(19) United States
(12) Patent Application Publication
(10) Pub. No.: US 2024/0211888 A1
(43) Pub. Date: Jun. 27, 2024

(54) SYSTEMS AND METHODS FOR ADAPTIVE EMPLOYMENT SEARCH AND RECRUITING USING MACHINE LEARNING

(71) Applicant: ZEIL Limited, Hong Kong (CN)

(72) Inventor: Anna Mowbray, Auckland (NZ)

(73) Assignee: ZEIL Limited, Hong Kong (CN)

(21) Appl. No.: 18/397,570

(22) Filed: Dec. 27, 2023

Related U.S. Application Data
(60) Provisional application No. 63/435,488, filed on Dec. 27, 2022.

(51) Int. Cl. G06Q 10/1053; G06F 3/04883; G06Q 10/0631

(52) U.S. Cl. CPC G06Q 10/1053; G06F 3/04883; G06Q 10/063112

(57) ABSTRACT

A method for employment searching includes determining one or more potential employment opportunities for a user. The one or more potential employment opportunities are determined as output from one or more matching algorithms or a user based search. The method also includes providing a graphical user interface comprising an employment card or series of employment cards for each of the one or more potential employment opportunities. The method further includes receiving, from the user, a first input gesture associated with a first employment card. The first input gesture represents an interest in a first employment opportunity from the one or more potential employment opportunities. The method includes automatically transmitting an electronic response to a poster of the first employment opportunity in response to the first input gesture.

### CROSS-REFERENCE TO RELATED APPLICATIONS

This application claims the benefit of priority of U.S. provisional application No. 63/435,488, filed Dec. 27, 2022, the entire contents of which are herein incorporated by reference.

### FIELD

The present disclosure relates to machine learning, searching and interfaces and, more particularly, to systems and methods for adaptive searching using machine learning with application to matching job search candidates with enterprises who post hiring opportunities. The disclosure also relates to systems and methods that deploy mobile devices to conduct such matching.

### BACKGROUND

Many computerized job search and recruiting platforms exist. Candidates can search for open positions posted by employers. Employers, in turn, can receive candidate submissions and judge whether to move an application to a next phase, such as an interview. However, most have limited functionality. From the candidate's point of view, existing platforms are not easy to use and lack any “social” aspect, for example, details on jobs that friends might have or will seek. From the enterprise point of view, existing platforms do not flexibly provide ways to market or “sell” the position to the candidate public.

As can be seen, there is a need for improved methods and systems for computerized job search and recruiting platforms.

### SUMMARY

In one aspect of the present disclosure, a method for employment searching includes determining one or more potential employment opportunities for a user. The one or more potential employment opportunities are determined as output from one or more matching algorithms or a user based search. The method also includes providing a graphical user interface comprising an employment card or series of employment cards for each of the one or more potential employment opportunities. The method further includes receiving, from the user, a first input gesture associated with a first employment card. The first input gesture represents an interest in a first employment opportunity from the one or more potential employment opportunities. The method includes automatically transmitting an electronic response to a poster of the first employment opportunity in response to the first input gesture.

In another aspect of the present disclosure, a computer-readable medium stores instructions for causing one or more processors to perform a method for employment searching. The method includes determining one or more potential employment opportunities for a user. The one or more potential employment opportunities are determined as output from one or more matching algorithms or a user based search. The method also includes providing a graphical user interface comprising an employment card or series of employment cards for each of the one or more potential employment opportunities. The method further includes receiving, from the user, a first input gesture associated with a first employment card. The first input gesture represents an interest in a first employment opportunity from the one or more potential employment opportunities. The method includes automatically transmitting an electronic response to a poster of the first employment opportunity in response to the first input gesture.

In another aspect of the present disclosure, a system includes one or more memory devices storing instructions and one or more processors. The one or more processors are configured to execute the instructions to perform a method for employment searching. The method includes determining one or more potential employment opportunities for a user. The one or more potential employment opportunities are determined as output from one or more matching algorithms or a user based search. The method also includes providing a graphical user interface comprising an employment card or series of employment cards for each of the one or more potential employment opportunities. The method further includes receiving, from the user, a first input gesture associated with a first employment card. The first input gesture represents an interest in a first employment opportunity from the one or more potential employment opportunities. The method includes automatically transmitting an electronic response to a poster of the first employment opportunity in response to the first input gesture.

### BRIEF DESCRIPTION OF THE DRAWINGS

FIG. 1 is a block diagram of a networked employment search environment, according to aspects of the present disclosure;

FIG. 2 is a block diagram of exemplary components of an employment matching system of the networked employment search environment of FIG. 1, according to aspects of the present disclosure;

FIG. 3A is a flow diagram of a method for employment matching, according to aspects of the present disclosure;

FIG. 3B is a flow diagram of a method for employment application editing, according to aspects of the present disclosure; and

FIGS. 4-51 are diagrams of graphical user interfaces for the employment matching system of FIG. 2, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

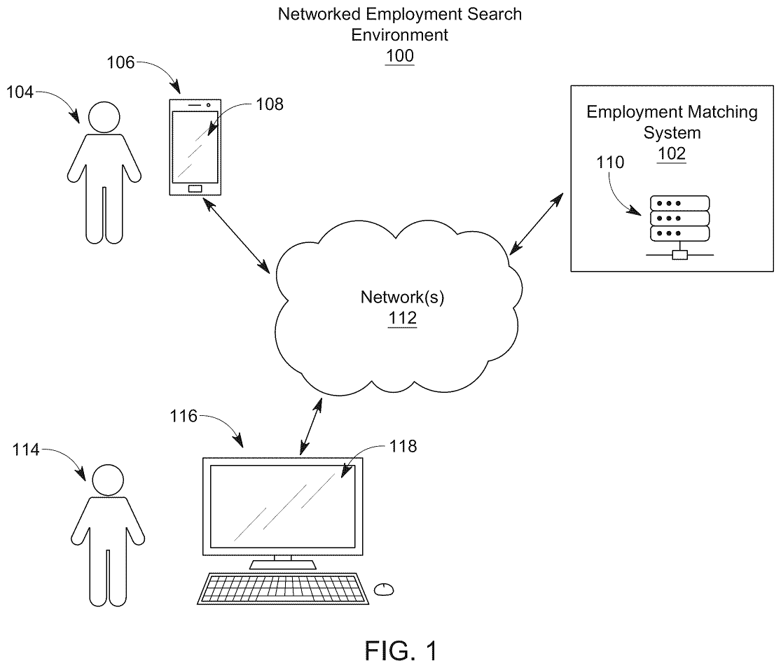

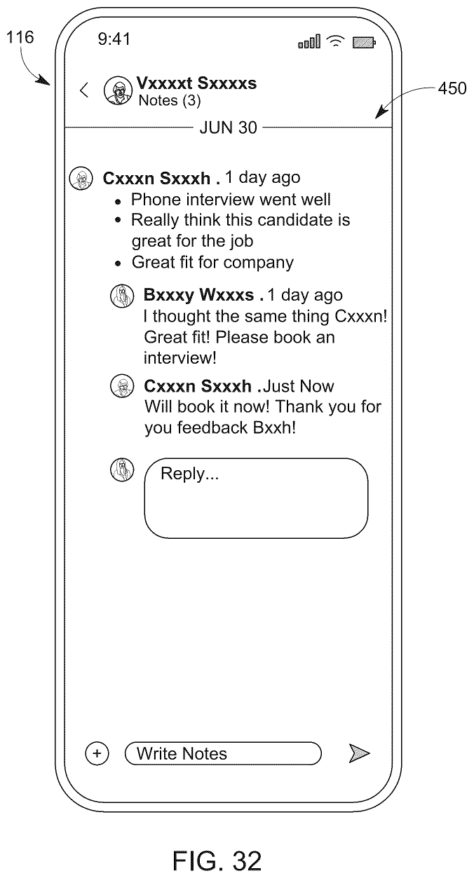

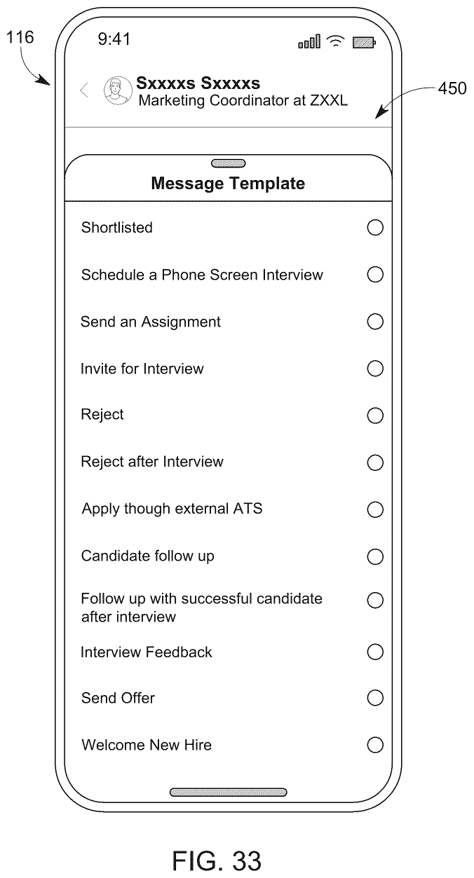

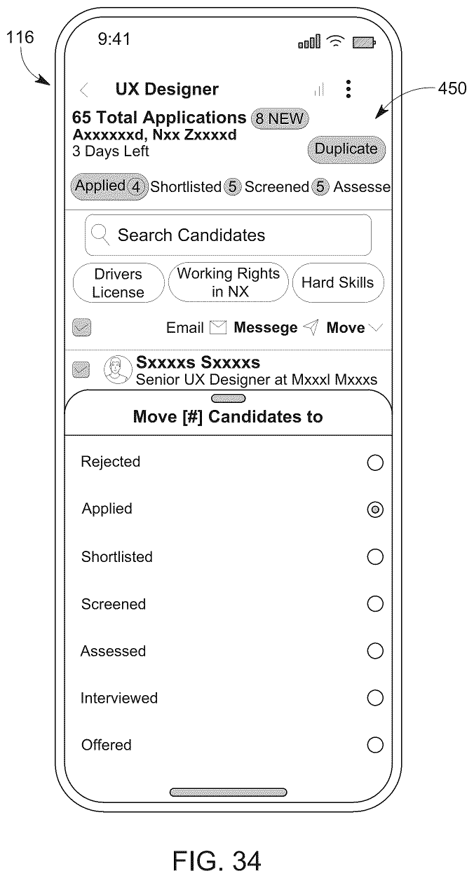

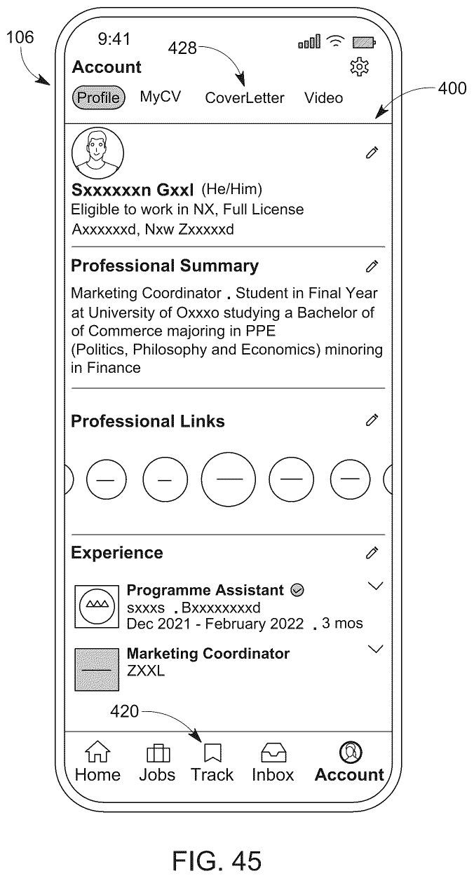

Referring now to FIG. 1-46, FIG. 1 illustrates a networked employment search environment 100, according to aspects of the present disclosure. The networked employment search environment 100 includes an employment matching system 102 that enables one or more users, e.g., a user 104, to be matched with potential employers, e.g., an employer 114. While FIG. 1 illustrates various components of the networked employment search environment 100, additional components can be added, and existing components can be removed.

In embodiments, the employment matching system 102 communicates with a user device 106 of the user 104 via one or more networks 112. Likewise, the employment matching system 102 communicates with an employer device 116 of the employer 114 via the one or more networks 112. The user device 106 and/or the employer device 116 can include one or more electronic devices such as a laptop computer, a desktop computer, a tablet computer, a smartphone, a thin client, a smart appliance, and the like. While FIG. 1 illustrates one user device 106, the networked employment search environment 100 can include multiple user devices 106 operated by the user 104 or operated by other users. Likewise, while FIG. 1 illustrates one employer device 116, the networked employment search environment 100 can include multiple employer devices 116 operated by the employer 114 or operated by other employers.

The employment matching system 102 provides a platform by which the user 104 can search for and apply to jobs, for example, posted by the employer 114. The employment matching system 102 can provide two types of graphical user interfaces (GUIs) for the job matching process. The employment matching system 102 can provide a candidate-facing GUI, e.g., a user interface 108 that is displayed on the user device 106. The employment matching system 102 can provide an employer-facing GUI, e.g., an employer interface 118 that is displayed on the employer device 116. Computer processing systems and devices 110 interact with the GUls to supply data manipulation and profile storage. In some embodiments, the GUls can be provided to one or more mobile applications executing on the user device 106 and/or the employer device 116 such as iOS or Android smartphones or tablets. In some embodiments, the GUls can be provided remotely through networked communication applications, e.g., presented within web-connected browsers.

In embodiments, a candidate, e.g., the user 104, builds a Curriculum Vitae (“CV”), which can operate as a digital profile. For jobs that are available, the user interface 108 provides an employment card that can be viewed and interacted with using one or more input gestures. For example, when there is a swipe right on an employment card, the CV is transmitted to an organization associated with the job, e.g., the employer 114. In some embodiments, the CV can be transmitted to the employer device 116 via an application programming interface (“API”) or through electronic messages, e.g., email. In embodiments, the employment matching system 102 can allow the user to create and update a CV to be transmitted to employers. The employment matching system 102 can allow a user to update a CV during the application process thereby allowing the user to customize their CV to each job, at the time of applying.

The employment matching system 102 can also provide, via the user interface 108 and/or employer interface 116, employment search; employment filters; social media platforms; employment posting saves; incomplete application saves; candidate tracking, maps and geolocating to the current place to feed jobs; imaging postings; split (A/B) testing of front card; demographic targeting of front cards or images; employer in-app job post creation; light applicant tracking system; and corporate analytics.

In embodiments, the employment matching system 102 can provide job matching and/or job searching using one or more machine learning algorithms. For example, the employment matching system 102 can input the digital profile of the user 104 to one or more machine learning algorithms to generate potential employment opportunities for the user 104. The employment matching system 102 can utilize Myers Briggs/Personality testing matching. The matching algorithms match roles to candidates and rank candidates in relation to the role. Such algorithms can also target roles to individuals based on a deep subset of preferences, Age/Ethnicity/Gender/Languages spoken/Degrees/Personality testing etc. Candidates will also be able to filter companies and roles based on what their culture or benefits look like, e.g., rainbow tick, B Corp, dog friendly, diversity embracing, youth tick, etc.). As such, the employment matching system 102 gives candidates, e.g., the user 104, the power to hunt based on what actually matters to them.

In embodiments, the employment matching system 102 can also provide candidate CV builder and profile GUI, which can provide a fully intuitive and comprehensive CV builder onboarding journey for candidates to fully create a CV. The employment matching system 102 can convert the CV into various formats to be exported, e.g., PDF using pre-defined and/or user-defined templates. The employment matching system 102 can populate a digital profile for the candidate using the created CV. The employment matching system 102 can also include a basic cover letter builder for candidates to create cover letters for each potential employment opportunity. Additionally, the CV can exist in the employment management system 102 in one of either two ways. First, the employment management system 102 can permit composing a new CV with a simple questionnaire selected by the user. After completion of the questionnaire, containing conventional field entries for experience, education, goals, etc. the system at the servers maintains such fields in a database, ready for presentation on a user device or employer device as a CV GUI for that particular person. Second, a user may have uploaded a CV via an upload thumbnail icon, from a CV file residing on a computer system of the user 104, e.g., the user device 106.

In embodiments, the employment matching system 102 can provide, via the user interface 108, a candidate job GUI. The candidate job GUI provides a novel, exciting and emotive way to display job advertisement cards, turning jobs from a “classified” style list item, into a fully visual and attractive advertisement with the ability to showcase the job/company. The user interface 108 can receive gesture input to interface with the employment card, e.g., swiping, as the main actuation for candidates. The employment matching system 102 can provide, via the user interface 108, distance to job functionality using the user's specific location and the job location. The employment matching system 102 can provide, via the user interface 108, search for any job based on key terms, industry, location, salary with the ability to save the search parameters. The employment matching system 102 can provide, via the user interface 108, filter functionality, e.g., filter the current employment card stack using filters such as work type, work style, days available, salary etc.

In embodiments, the employment matching system 102 can provide a candidate network that can allow searching for and adding/inviting users to your network; showing suggested contacts; and following organizations. The employment matching system 102 can provide, via the user interface 108, candidate Messaging functionality, e.g., functionality for the user 104 to message between people in their network.

In embodiments, the employment matching system 102 can provide a candidate application tracking system (“ATS”). The employment matching system 102 can provide, via the user interface 108, tracking and visualization of the history of all employment cards interacted with—passed, saved, applied. The employment matching system 102 can provide, via the user interface 108, tracking the status of applied jobs and the ability to communicate with the organization/employer. Status of applied jobs can be shown visually via a graphical milestone progress bar, additionally including textual indications of what is the current status (e.g., first intake, under completeness review, under decision maker review, pending scheduling of interview, post-interview, etc.).

In embodiments, the employment matching system 102 can provide one or more job matching and/or searching algorithms to identify potential employment opportunities for candidates, e.g., the user 104. The employment matching system 102 can utilize one or more weighted scoring algorithms for determining matches for potential employment opportunities, as described below. The employment matching system 102 can utilize one or more trained machine learning algorithms. The one or more trained machine learning algorithms can utilize natural language processing (NLP) techniques to match jobs to candidates. For example, various data points (e.g. job title and job description) embeddings are generated and then a cosine similarity is used to score the similarity between user and job profiles. Jobs with the highest scores will be recommended to the candidates. The one or more machine learning algorithms can utilize self-learning processes to tune the one or more machine learning algorithms to specific users, specific employers, specific job fields, specific demographics, and the like. The job matching algorithms can match job advertisements to candidates based on candidate profile data points (e.g. location, work experience, education, skills, similar people, etc.). The employment matching system 102 can provide, via the user interface 108, a candidate homepage. The candidate homepage can include a dashboard for candidates to view analytics, profile completion stats, organization feeds, etc.

In embodiments, the employment matching system 102 can provide enterprise features that allow the employer 114 to manage job postings, communicate with potential candidates, etc. The employment matching system 102 can provide an enterprise portal. The enterprise portal can provide an enterprise “logged in state” to manage their brand page, jobs, applicants, ATS, administration/accounts etc. The employment matching system 102 can provide, via the employer interface 118, an enterprise organization onboarding/builder. The builder can provide a fully intuitive enterprise/organization brand page builder that creates the brand profile showcasing the organization.

In embodiments, the employment matching system 102 can provide, via the employer interface 118, one or more enterprise job postings. The job posting can include simple job posting functionality to allow organizations/employers to post a job from a pre-established template from scratch. The job posting can include a feature to add employment card creative, e.g., up to 5 images. The job posting can provide split testing of the first image allowing organizations to test which image has the most impact.

### Enterprise ATS

In embodiments, the employment matching system 102 can provide, via the employer interface 118, tracking and management of candidate applications and statuses on jobs. The employment matching system 102 can provide, via the employer interface 118, tracking and management of all active and past jobs. The employment matching system 102 can provide, via the employer interface 118, enterprise communication. The communication can include templated or freeform employer to candidate messaging.

In embodiments, employment matching system 102 can provide an enterprise homepage. The enterprise homepage can include a dashboard for enterprises to view analytics, brand page completion stats, their posted feeds, active jobs etc.

In embodiments, the employment matching system 102 can provide, via the user interface 108 and/or the employer interface 118, general features of a website, including a platform brochure/informational website for a candidate (main features/help articles/FAQs) or Enterprise (features, sales, pricing, help articles, FAQs). The employment matching system 102 can provide, via the user interface 108 and/or the employer interface 118 analytics on the job matching. The analytics can include data metrics covering both candidates and enterprise: candidate analytics; profile views; profile reactions, number of new contacts; enterprise analytics, brand page views; brand page reactions; number of new followers; number of page video views; page video view completion metrics; brand feed post reach; brand feed post engagement; job campaign reach, clicks, engagement; employment card reach, clicks, engagement; return on job campaign; cost per fulfillment.

In embodiments, the employment matching system 102 can provide push and in-app notifications to the user device 106 and the employer device 116. The notifications can include notifications to candidates and enterprise (e.g., when they get a message, when they receive an application etc.) the employment matching system 102 can provide p election message communications such as service/transactional emails (e.g., invite emails, reset password, job posted successfully, etc.); marketing emails (e.g., user feedback emails, reminder emails, weekly digest, etc.) and the like. The employment matching system 102 can provide, via the user interface 108 and/or the employer interface 118, a settings page for administration of the user's account and links to standard legal terms, FAQs, etc.

The employment matching system 102 includes computer processing systems and devices 110 that perform the processes and methods described herein. The computer processing systems and devices 110 can include physical computer processing systems, server computer systems, and/or cloud-based computer processing systems. As used herein, a “cloud” “cloud service”, and/or “cloud-based computer processing systems” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

The term “server” can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

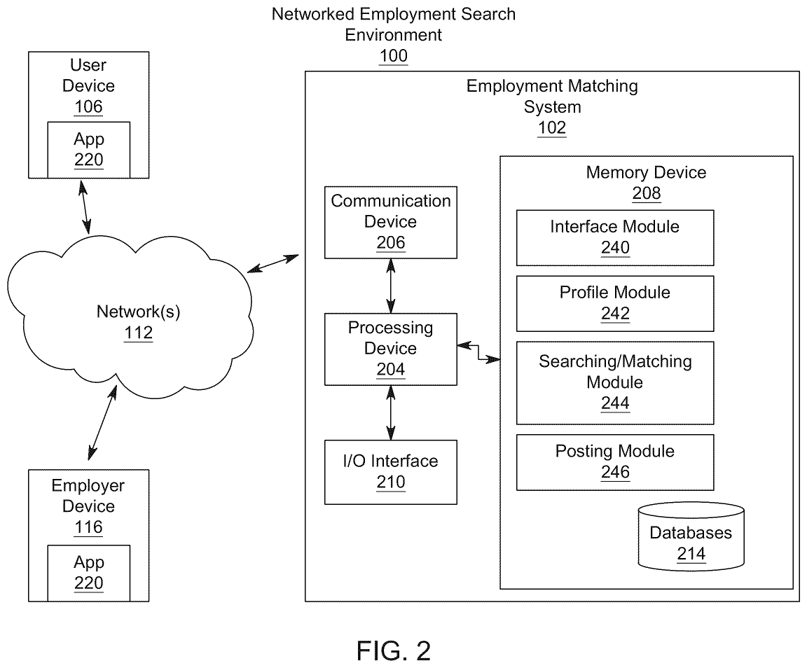

FIG. 2 illustrates exemplary components of the employment matching system 102, according to aspects of the present disclosure. While FIG. 2 illustrates various components of the networked employment search environment 100, additional components can be added, and existing components can be removed.

As illustrated in FIG. 2, the employment matching system 102 includes one or more processing devices, herein processing device 204, coupled to a communication device 206. The processing device 204 is also coupled to a memory device 208, and an input/output (“I/O”) interface 210. In embodiments, the communication interface 204 enables the employment matching system 102 to communicate with other devices and systems, e.g., the user device 106 and/or the employer device 116 via the one or more networks 112.

According to the aspects of the present disclosure, the employment matching system 102 enables the user 104 and/or the employer 114, operating a copy of an application 220 executing on the user device 106 and/or the employer device 116, to communicate with the employment matching system 102 and leverage the service provided by the employment matching system 102.

To perform the process described herein, the employment matching system 102 can store and execute an interface module 240, a profile module 242, a searching/matching module 244, and a posting module 246 to perform the processes and methods described herein. The interface module 240, the profile module 242, the searching/matching module 244, and the posting module 246 can be stored in the memory device 208. The interface module 240, the profile module 242, the searching/matching module 244, and the posting module 246, as well as the application 220, can include the necessary logic, instructions, and/or programming to perform the processes and methods described in further detail below. The interface module 240, the profile module 242, the searching/matching module 244, and the posting module 246, as well as the application 220, can be written in any programming language.

In embodiments, the application 220 can be a specifically designed application that operates with the employment matching system 102 to perform the processes and methods described herein. In embodiments, the application 124 can be a third-party application, such as a web browser, that communicates with the employment matching system 102 to perform the processes and methods described herein. The memory device 208 can also include one or more databases 214 that store information and data associated with the process and methods described below in further detail. For example, the one or more databases 214 can store the CVs of the candidates/users, the digital profiles of the candidates/users, the job posting of employers, and any other data used in the processes described herein.

According to aspects of the present disclosure, the employment matching system 102, for example, via the interface module 240, communicates with the application 220 to provide unique interfaces that allow the user 122 to view employment cards, create profiles, create job posts, etc. The interface module 240 operates to generate and provide GUIs to the application 220 (or provide data to the application 220 to generate the GUls), for example, menus, widgets, text, images, fields, etc., as described below in further detail. The GUIs generated by the interface module 240 and/or the application 220 can be interactive. The employment matching system 102, for example, via the interface module 240, (or the application 220) can also provide one or more application programming interfaces (APIs) that provide connection points for one or more applications and services of the employing matching system 102.

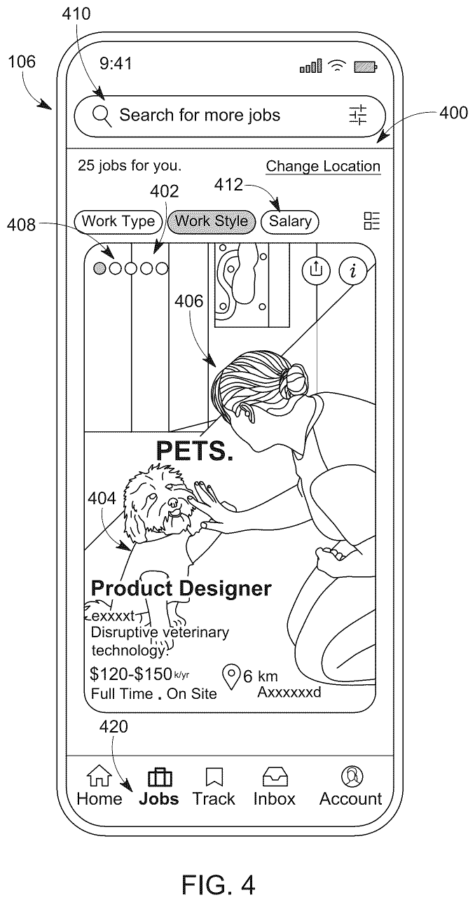

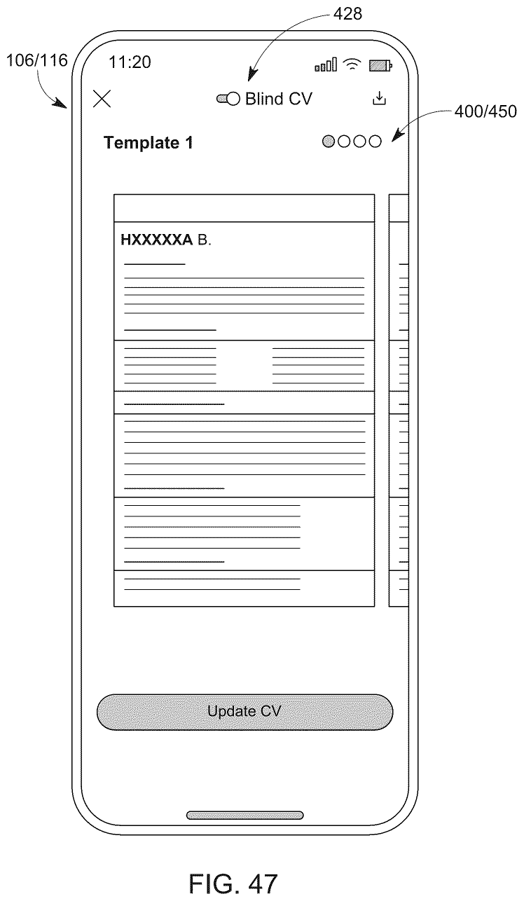

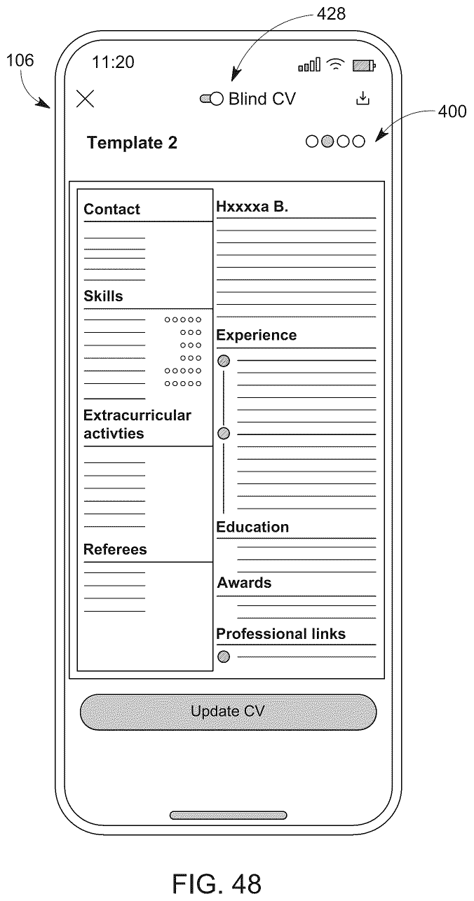

For example, the employment matching system 102, for example, via the interface module 240, (and/or the application 220) can generate the user interface 108 and/or the employer interface 118. FIGS. 4-48 show examples of GUIs that can be generated by employment matching system 102, for example, via the interface module 240, (and/or the application 220). As illustrated in FIG. 4, a candidate (or user) interface 400 can include an employment card or a series of employment cards (hereinafter employment cards 402), which can be matched to the candidate via matching algorithms. The employment cards 402 can include multiple images 406 that convey a field of the job, the employer, and the like. The employment cards 402 can also include details 404 of the job such as job title, job description, pay rate, average salary, distance from work, what sort of workers are sought: part-time, full-time, remote etc. The employment cards 402 can include a series of cards that can be navigated by the user 102 by using gestures or inputs. Each card in the series of employment cards 402 includes different information about the employment opportunity. Each card in the series of employment cards 402 can include a navigation indicator 408 that informs the user 102 how many cards are in the series and which card is currently displayed.

The candidate interface 400 can also include a search bar 410, which can receive search terms entered by the user 104. The candidate interface 400 can also include filter widgets 412 that allows the user 104 to sort and/or display the employment cards 402 by categories such as work type, work style, salary, and the like. The candidate interface 400 can also include one or more navigation widgets 420 for accessing different interfaces and services such as a home page, a job page, a tracking page, a message interface, a social network, an account page, and the like.

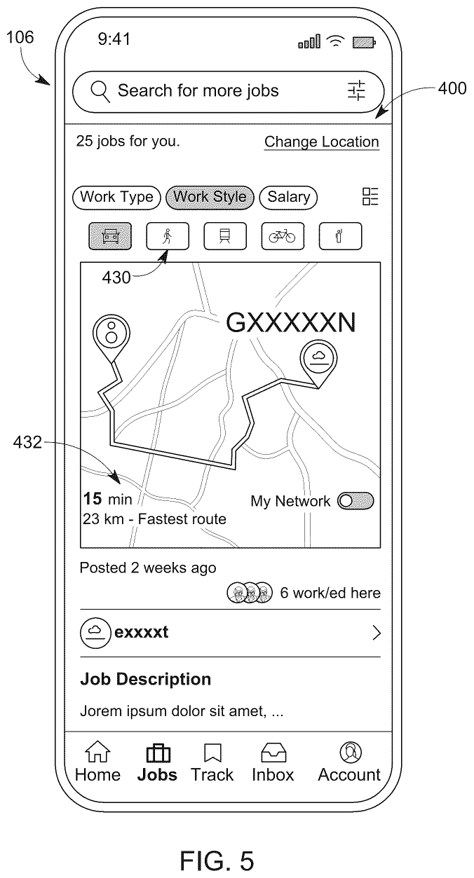

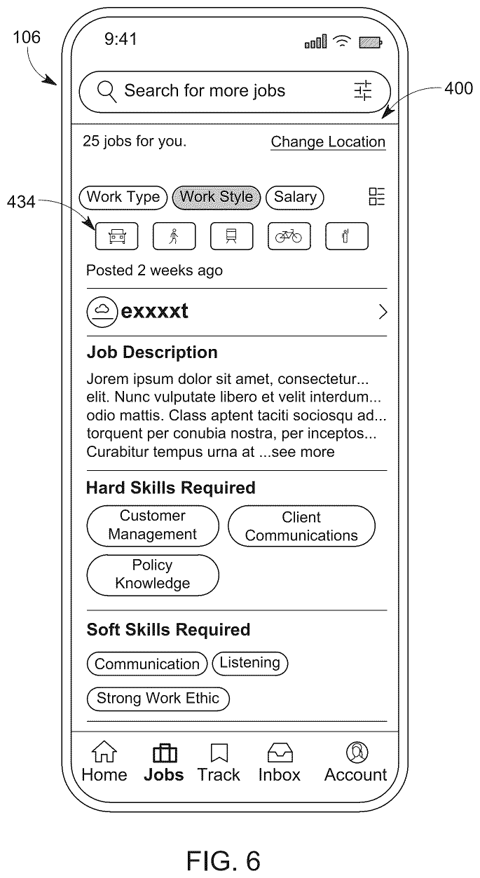

The employment cards 402 can be navigated by gesture input performed by the user 104. For example, scrolling down reveals information that gives locations mapping 430 in relation to the role; via car, walking, bus, etc., as illustrated in FIG. 5. In this instance, the employment matching system 102 and/or the application 220 can utilize the GPS-style location-identifying functionality that resides already on the user device 106. Additionally, scrolling down, a candidate can see, in field 432, which of his or her friends work at the company or have worked there before. The candidate can click into that to get more details 434 such as job description, full details, corporate, about us and the company details, as illustrated in FIG. 6.

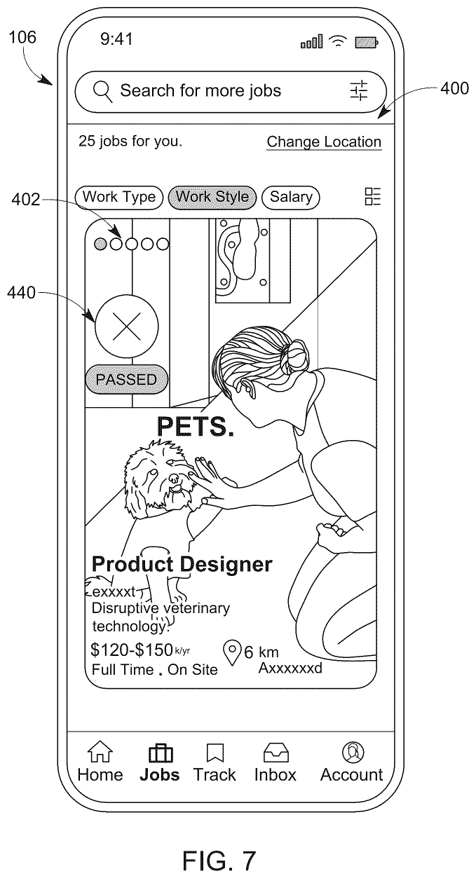

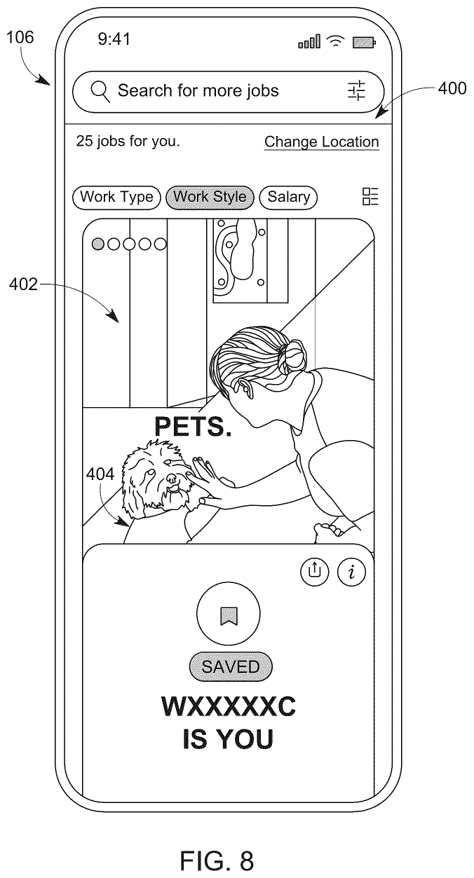

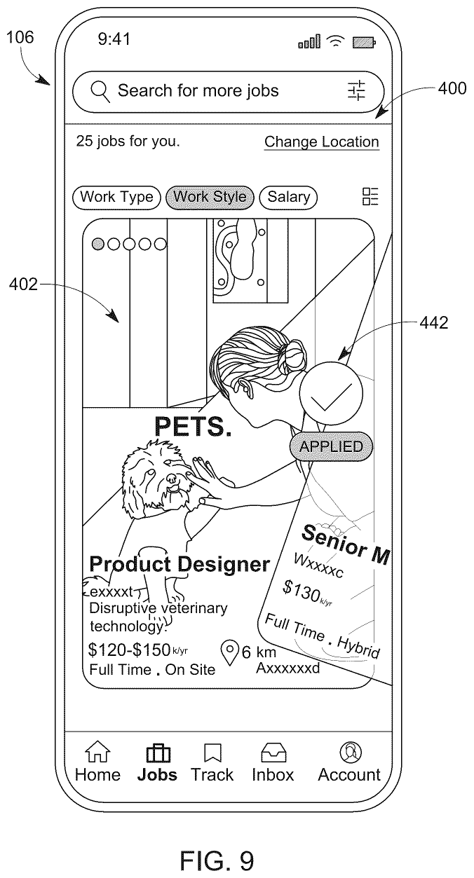

Scrolling back up, a candidate can share this role to others in his or her network, thus taking advantage of social networking within the app. Selectable icons will show which contacts already work at the company or have worked there. The candidate can decline the employment card by swiping left, and discarding that job profile from the user experience as illustrated in FIG. 7. An icon 440 can be displayed on the employment card indicating that the user 104 passed on the employment opportunity. Or, the candidate can save the job profile for review later by swiping down as illustrated in FIG. 8. In a third option, the candidate can swipe right to begin applying for the job as illustrated in FIG. 9. In this option, in some embodiments, the CV of the user 104 can be automatically transmitted to the employer associated with the employment card. An icon 442 can be displayed on the employment cards 402 indicating that the user 104 passed on the employment opportunity.

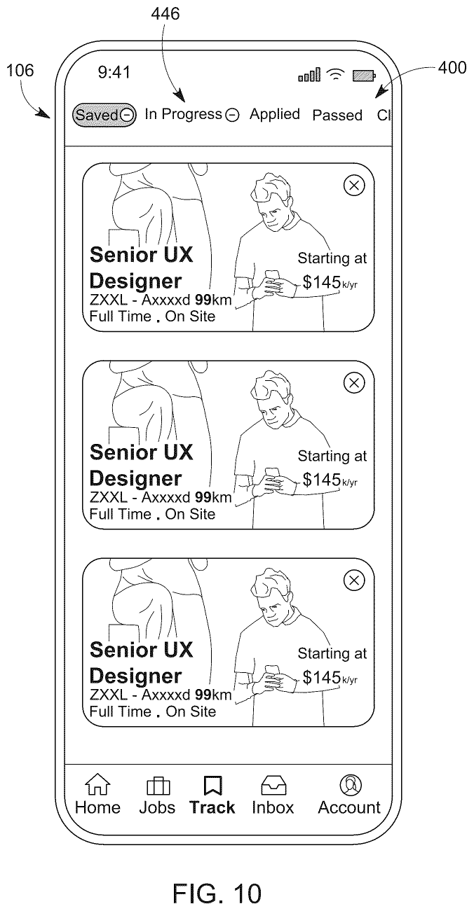

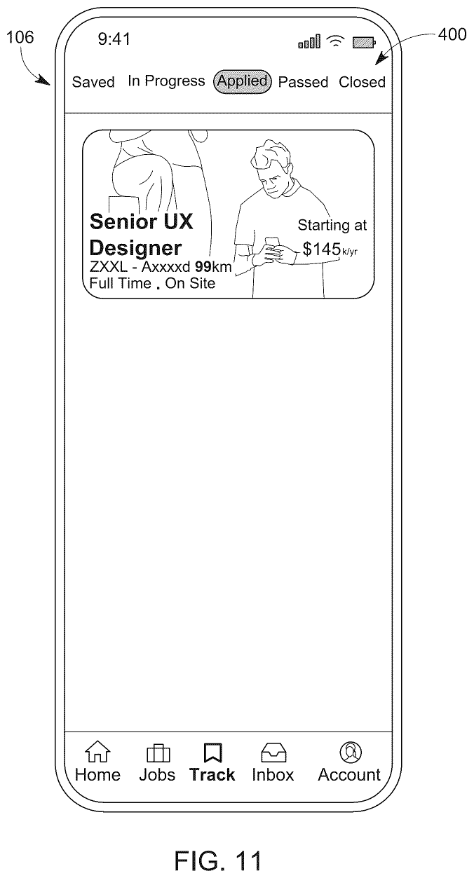

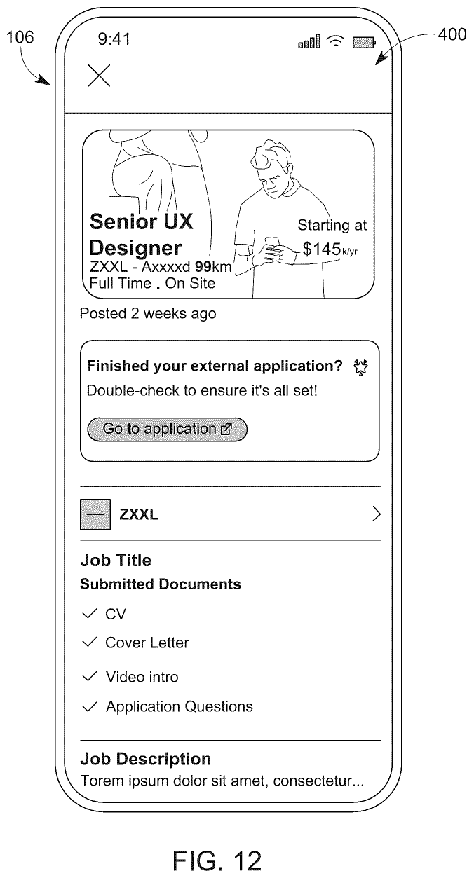

The candidate interface 400 allows the user to view the status of jobs that have been viewed, saved, or in progress, as illustrated in FIG. 10. As illustrated, a number of category widgets 446 can display a number of the status categories that the user 104 can select. By selecting the category widgets 446, the candidate interface 400 can display the employment cards 402 in that category, for example, in a tiled format, as illustrated in FIG. 10. If the user 104 selects employment cards, the user 104 can view their status with the particular employment opportunity. For example, as illustrated in FIG. 11, if the user 104 selects an “applied” widget, the employment cards for jobs applied to are displayed. As illustrated in FIG. 12, the candidate interface 400 can display the details of the application, for example, the documents submitted, the employment cards, a widget to update the job application, and the like.

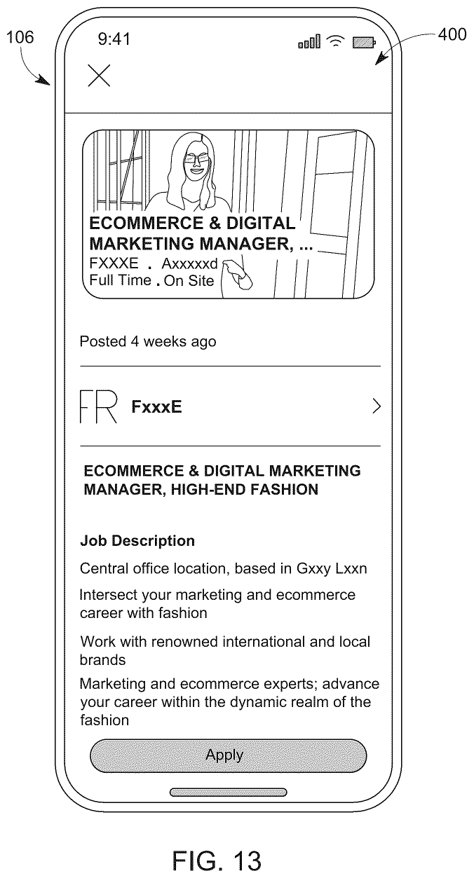

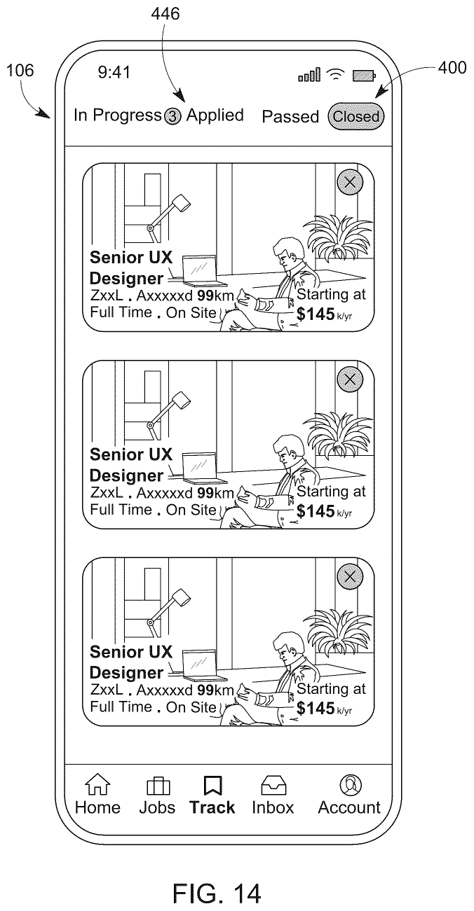

As illustrated in FIG. 13, if a job is saved, the user 104 can visit the job later and apply, by clicking on the “tracking” widget in the widgets 420. Saving allows the candidate to add more depth and more materials to an application. If a candidate has saved a role, the user 104 can add a customized video intro, customized cover letter, or, can customize a CV before formally applying. Thus enhanced, a candidate's job application can instantly be submitted to the enterprise, again through a swipe-right gesture. As illustrated in FIG. 14, by selecting the “closed” widget from the category widgets 440, the user 104 can review jobs that were closed by the employer. The employment matching system 102 and/or the application 220 can also track applied-for jobs as discussed above. Similar to how consumers manage a package ordered from an online marketplace, the candidate can manage the tracking of the role, through linkages between the corporate and the enterprise version of the app. When enterprises change the status of an application, the employment matching system 102 and/or the application 220 updates the status for the candidate. The employment matching system 102 and/or the application 220 can check all the details of roles they have passed on, applied for, or saved.

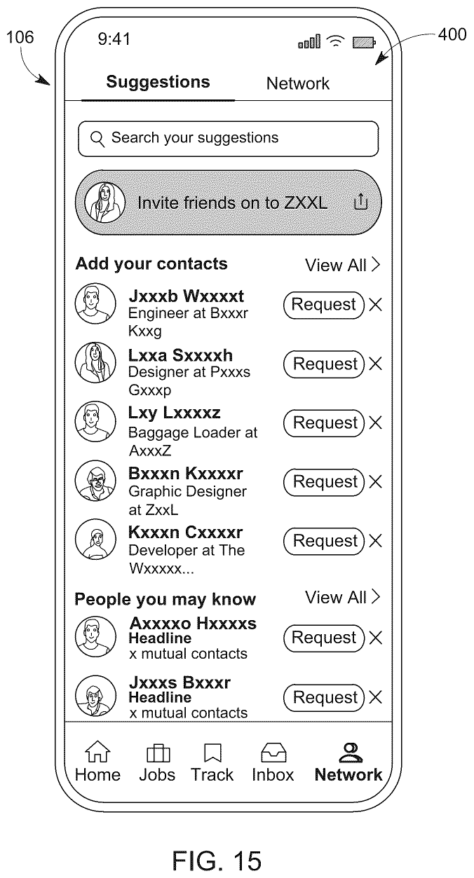

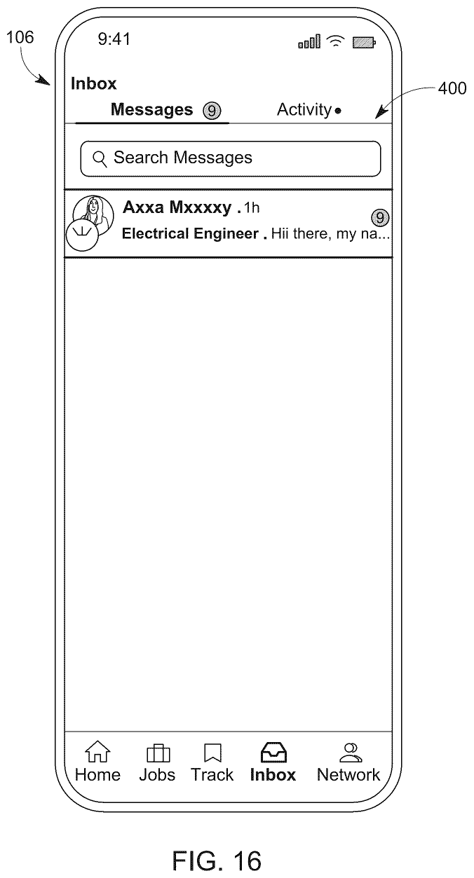

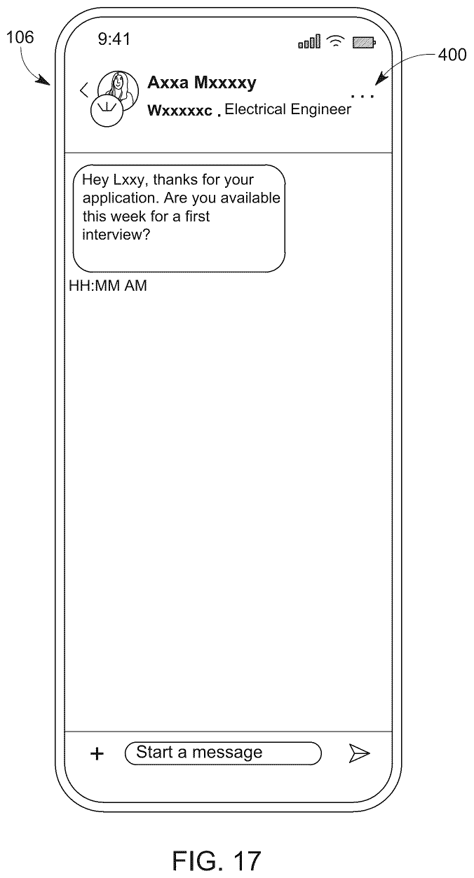

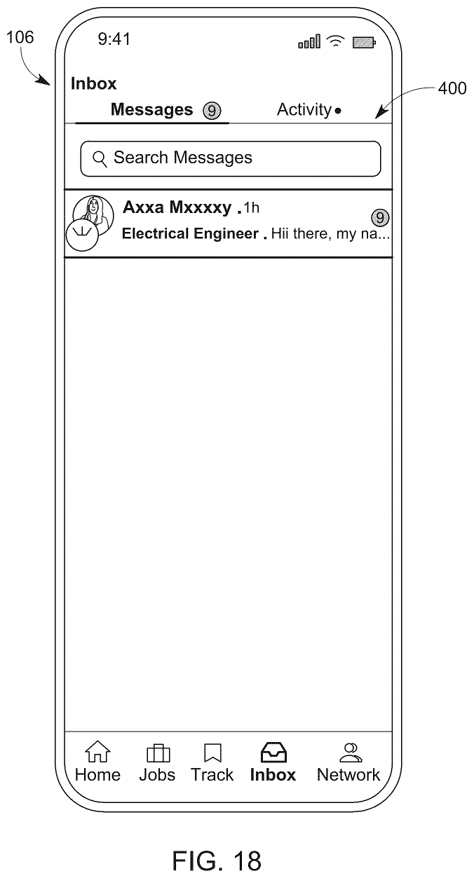

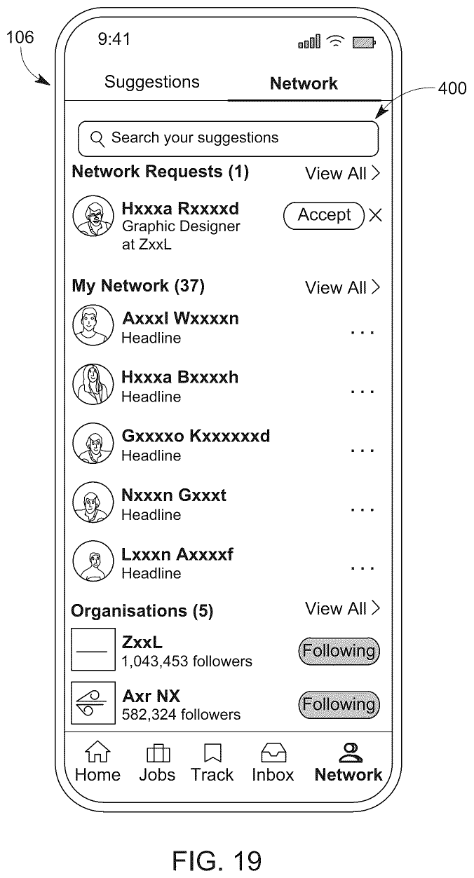

Screen icons link to a candidate's phone and their inbox, or to icons they can select to connect with people, as illustrated in FIG. 15 and FIG. 16. Selectable icons allow the candidate to follow organizations and thereby get access to their feeds, as illustrated in FIG. 19. Candidates can select icons to communicate with organizations, through messaging routed through the platform as illustrated in FIGS. 17 and 18. Icons similarly allow communicating with friends that are in the candidate's network, as illustrated in FIG. 15 and FIG. 19.

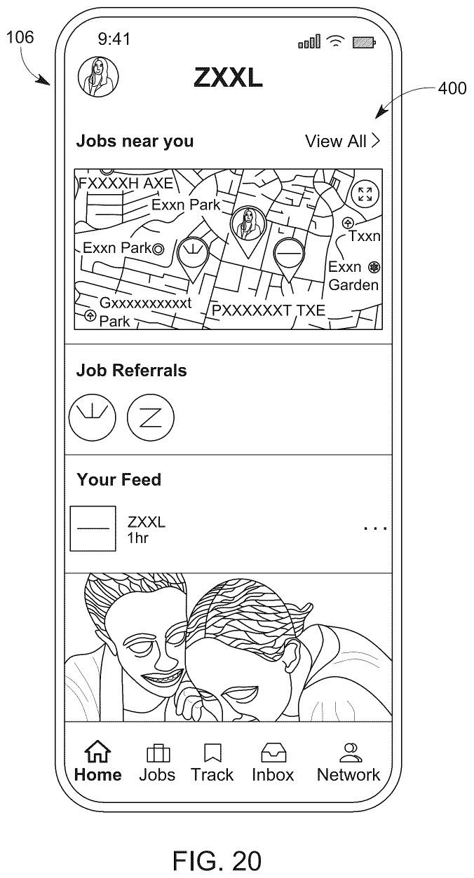

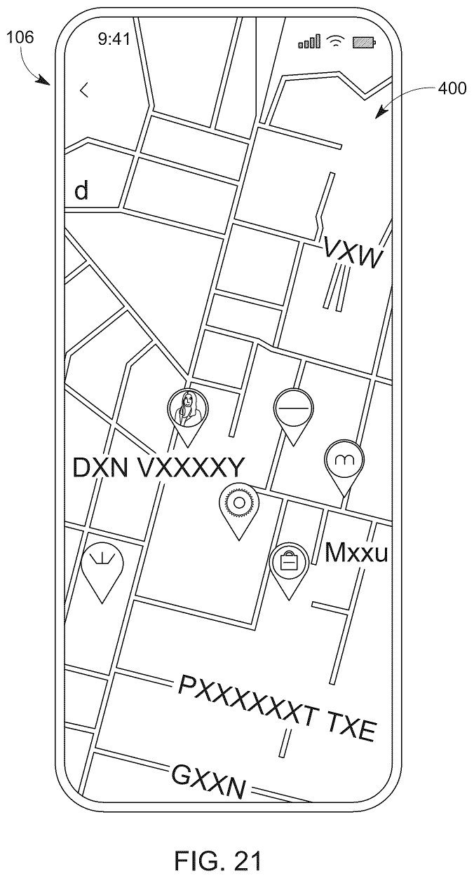

The candidate's “home” screen can include a map which shows mobile device location and where all the jobs are in relation to that, as well as the person's network, or friends that might be in that particular role, as illustrated in FIG. 20 and FIG. 21.

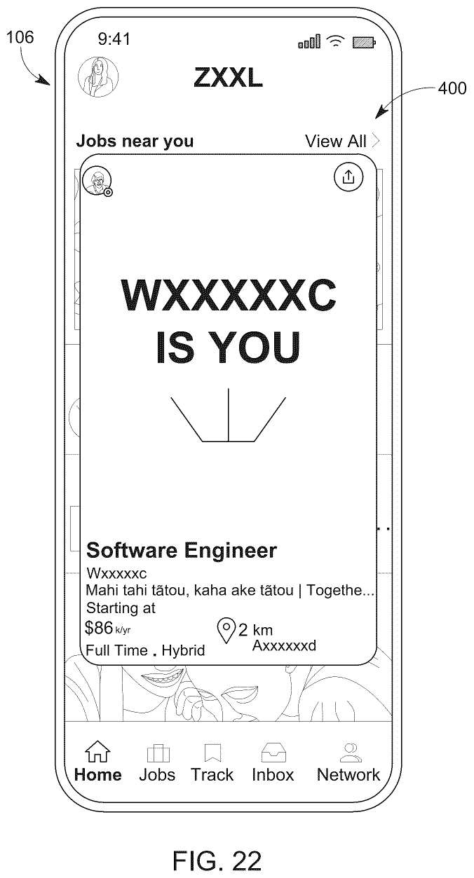

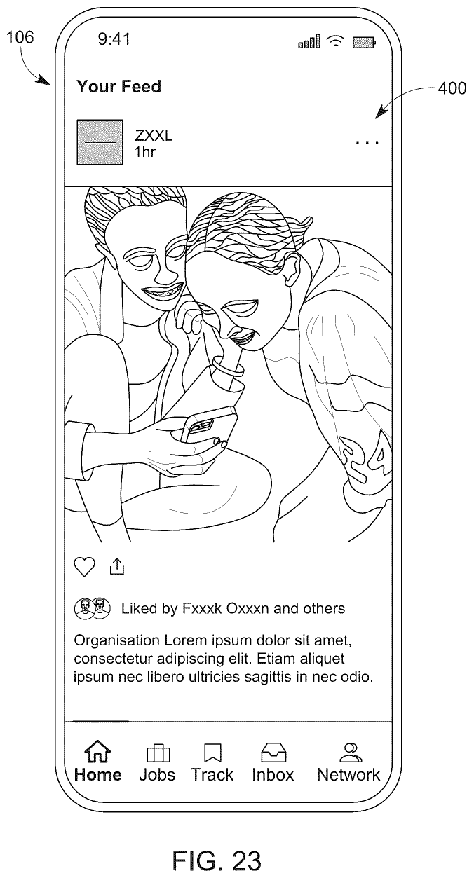

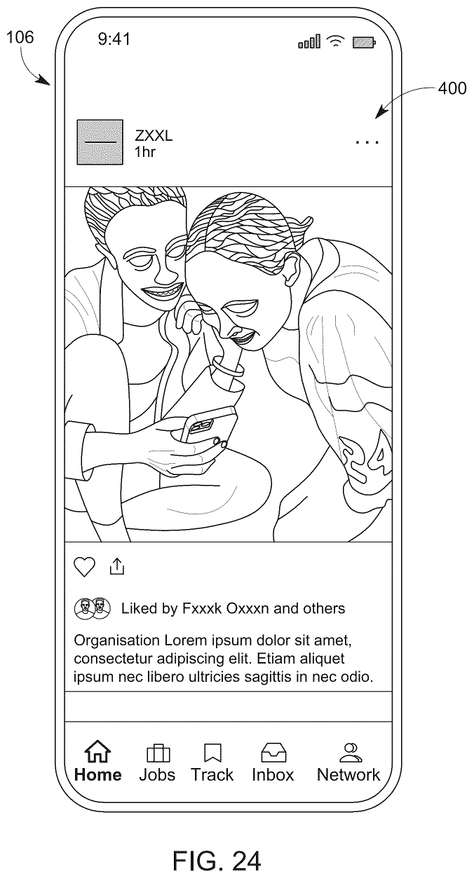

On the home page as well, there can be referrals, which is a gamified platform which when someone refers a job to the candidate, it will come up to the top of the employment card stack, as illustrated in FIG. 22. The candidate can see who referred to it in the top corner as well and will be able to apply for it. The referrals can allow organizations to monitor and to allocate points to people that have referred them roles, whereby a leaderboard can be displayed. Enterprises can give compensation if app users endorse people, refer people, and certain of those people are employed and stay at the company for a certain time. The employment matching system 102 and/or the application 220 also displays basic analytics for the candidate and a news feed which organizations push through, as illustrated in FIG. 23 and displays information around jobs already applied for as illustrated in FIG. 24.

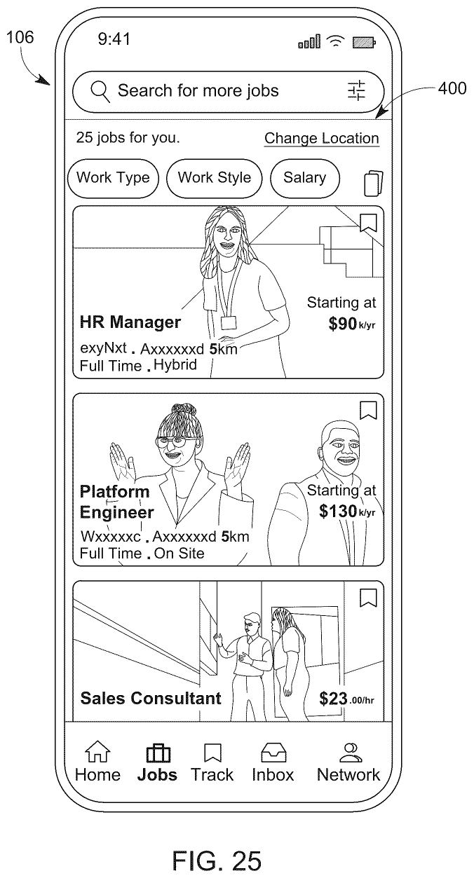

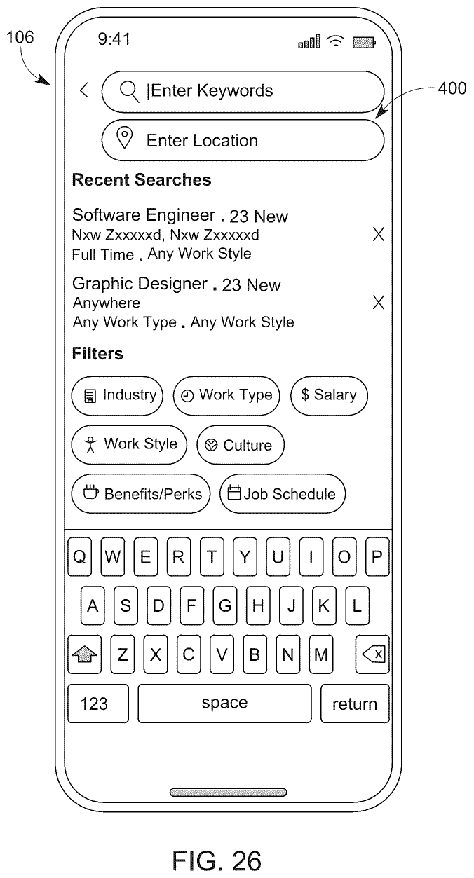

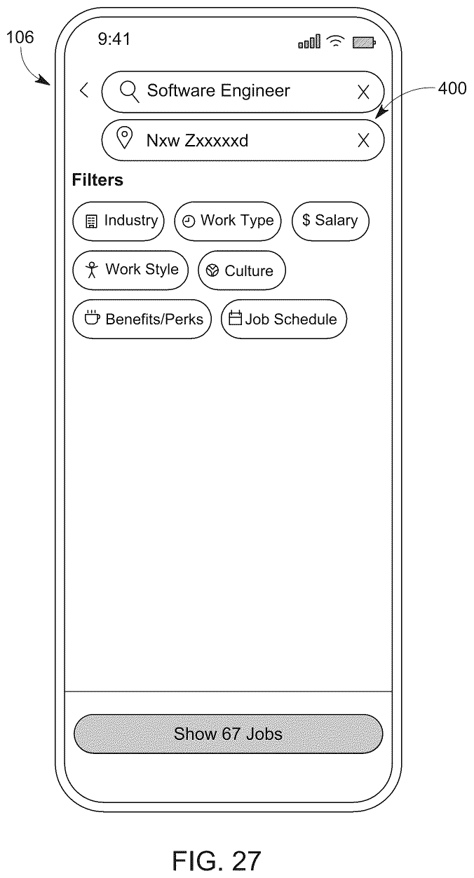

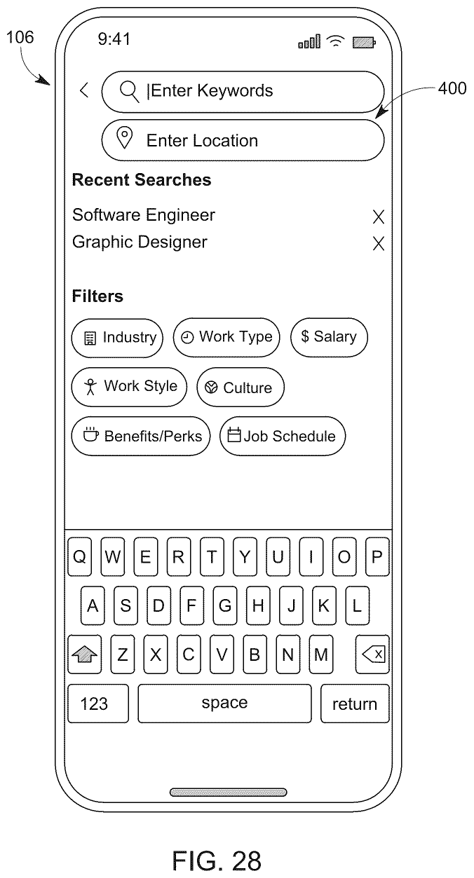

The employment cards can be viewable in a tile format with rounded corners, also, as illustrated in FIG. 25. Candidates can select a card tile, then apply as described above. The candidate interface 400 can also include search functionality that allows searching based on search terms, filters, categories, and the like. Search is also provided, by job title, skill, classification, industry, location or company or just a keyword, as illustrated in FIG. 26. In particular, a search can broaden or tighten the target location. Filtering search is also provided, so the filters are there to align to what the candidate wants in a card stack. So, if a candidate would like to see full or part time roles, the working style, etc., hybrid, remote, filters can be used, as illustrated in FIG. 27. Days or times of availability, recent roles, older roles, and how many job postings are displayed are also available filter parameters, which can be saved, as illustrated in FIG. 28. Also, so that in future those are the priority preferences that come through in the stack of cards that gets provided, the stack of cards is based on like for like audiences, candidate age, candidate stage, or where the candidate is in their recruitment or career journey. Such factors decide how cards are allocated and matched. Matching and targeting is not exclusively through filters and search, but also the aforementioned demographics and personality testing and like for like audiences, to make sure more obscure roles and opportunities get displayed as well as more obvious ones. Likewise, matching and targeting can be based on user's behaviors and interactions with the employment matching system 102 and/or the application 220 such as gesture behavior, interactions, and patterns (e.g., swiping behavior).

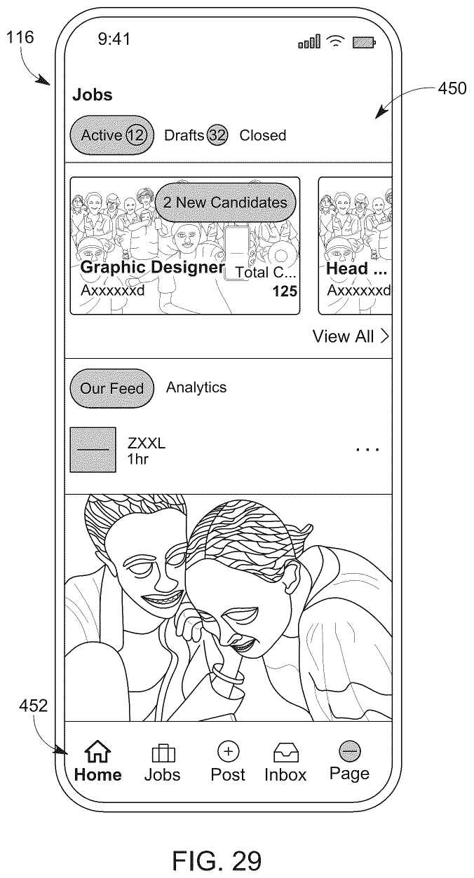

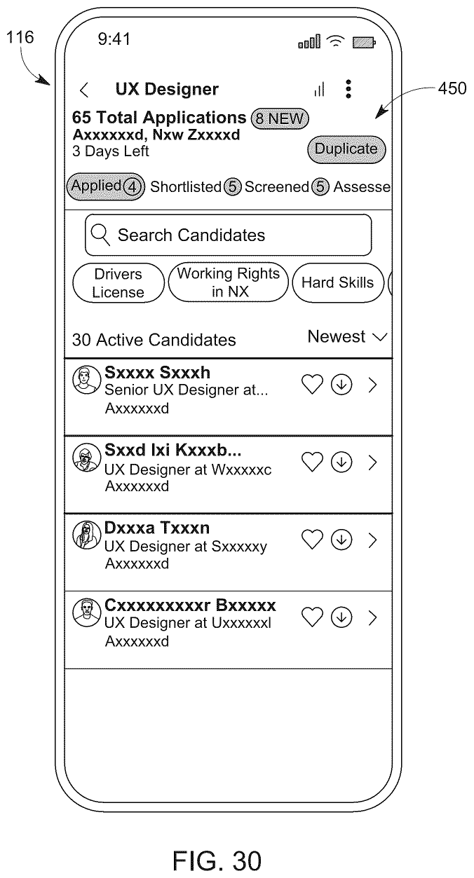

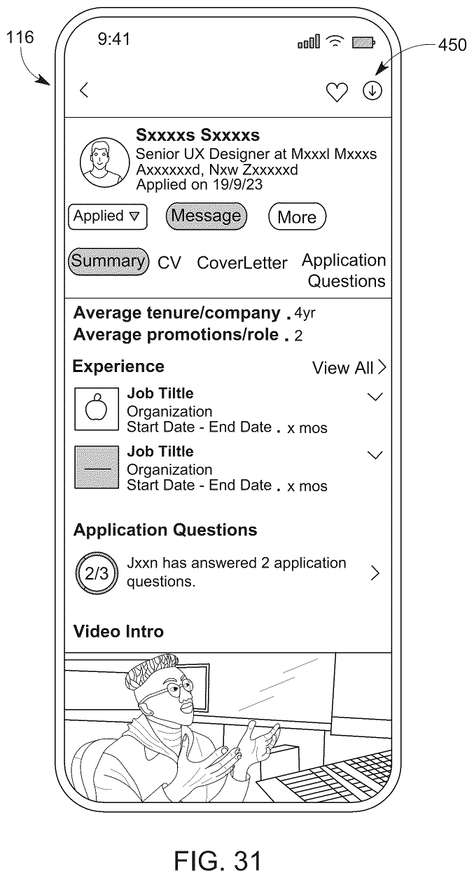

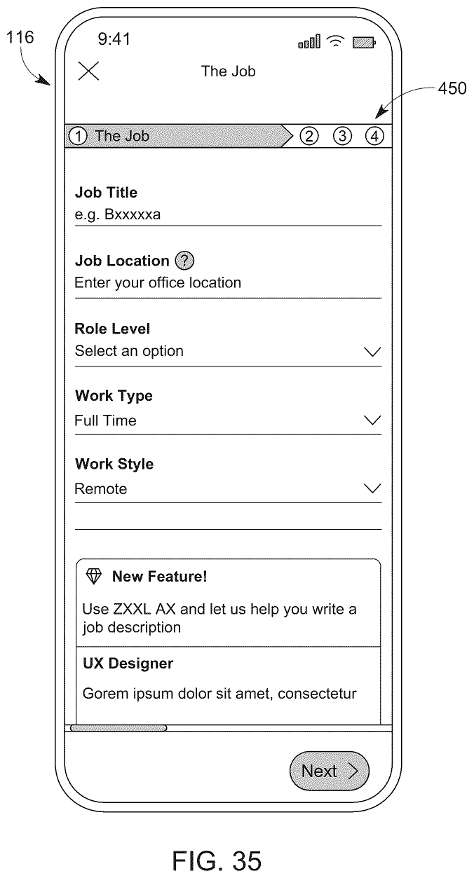

In embodiments, the employment matching system 102, for example, via the interface module 240, (and/or the application 220) can generate interfaces for organizations, e.g., the employer interface 450, where they can manage their different roles, they can post a new job, they can review their analytics, and they can look at their feed for example, using widgets 452, as illustrated in FIG. 29. It includes an applicant tracking system showing all the candidates who have applied, and that they will be matched to the role as well, as illustrated in FIG. 30. This interface allows review of the cover letter, the video intro, the digital candidate profile, allows for communication with notes across hiring managers, and generates template messages to invite candidates to interviews, etc., as illustrated in FIGS. 31, FIG. 32, FIG. 33, and FIG. 34. This interface can also change candidate status at the organizational side, and when that is done, it updates the status for the candidate and their app as well, as illustrated in FIG. 35.

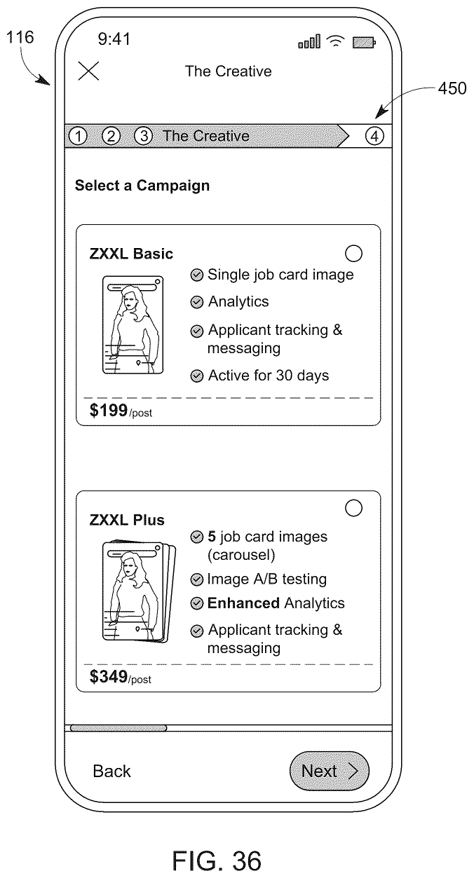

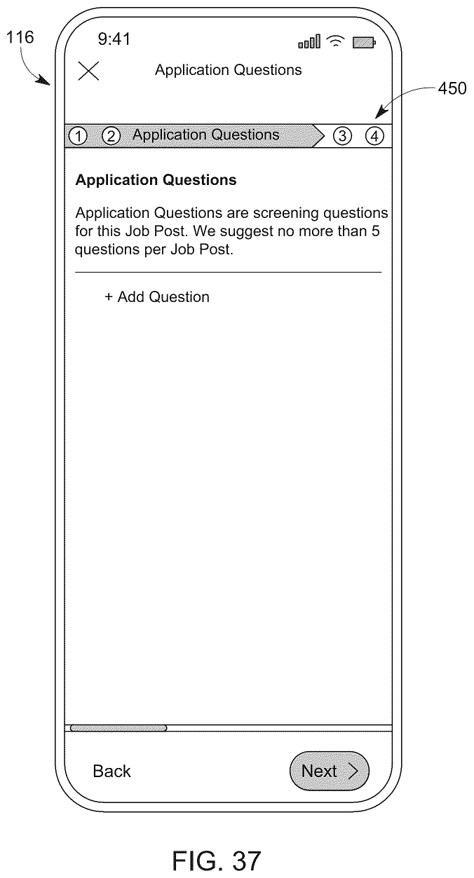

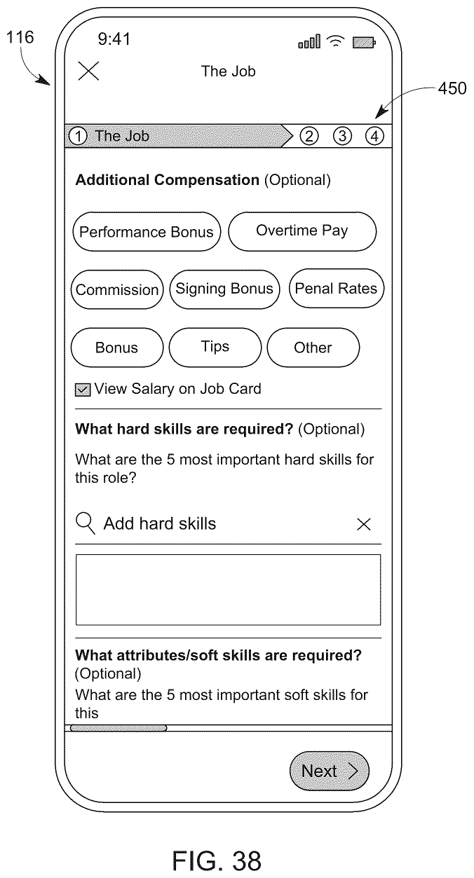

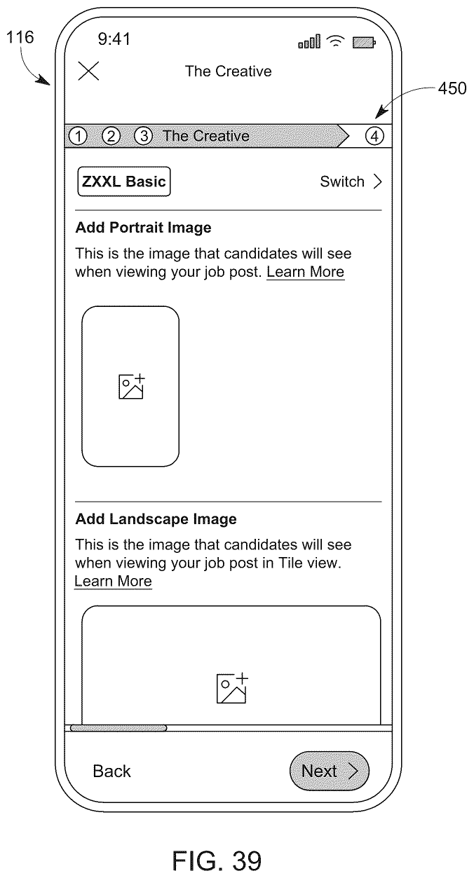

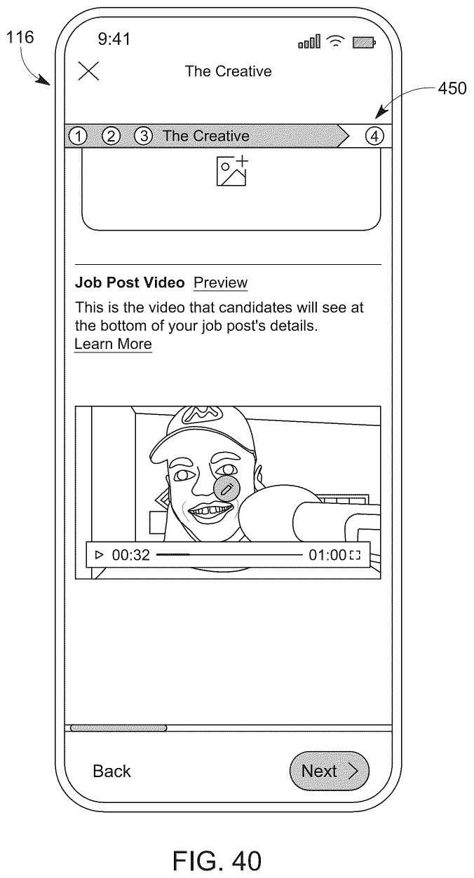

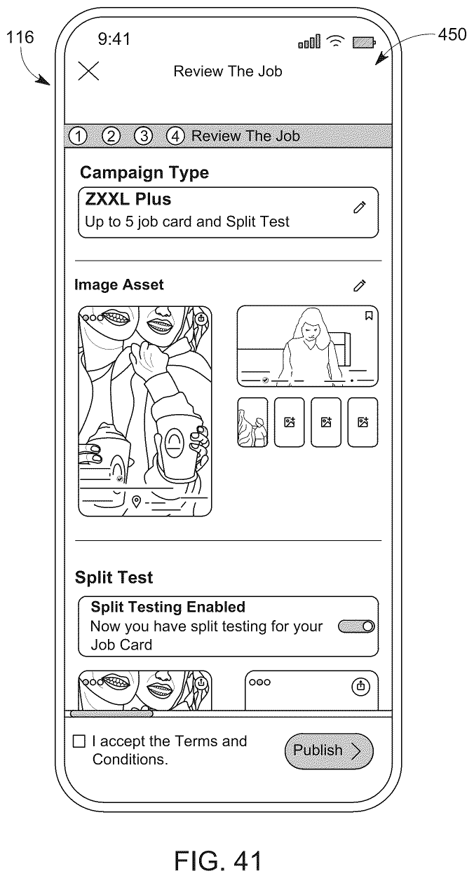

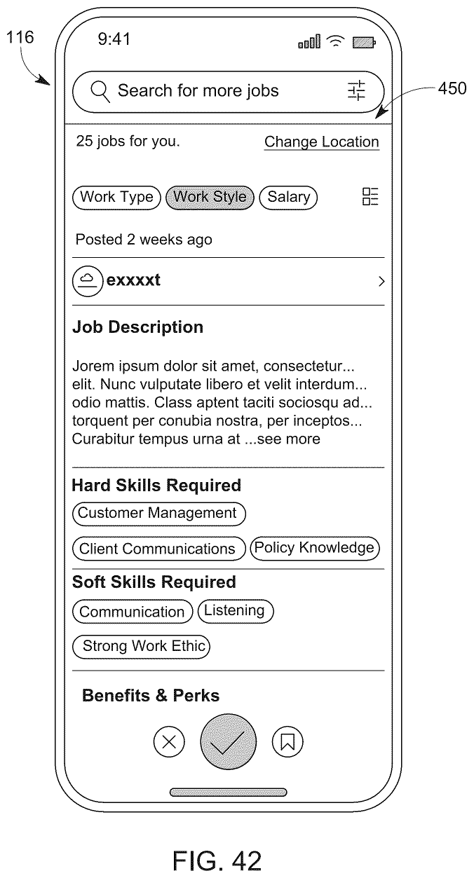

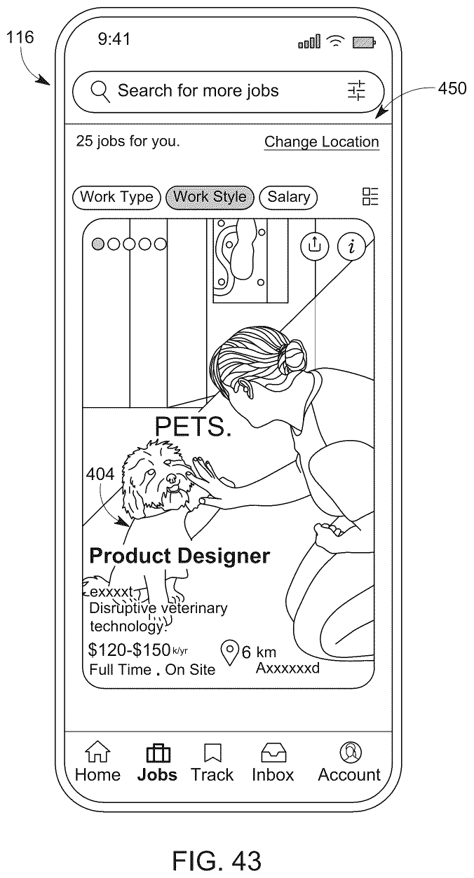

In embodiments, employment matching system 102, for example, via the interface module 240, (and/or the application 220) can generate interfaces for organizations, e.g., the employer interface 450, where to post a job, as illustrated in FIG. 35. Choices for the campaign can be provided either to make it basic, which is one card plus some information, or a five card stack, as illustrated in FIG. 36. The employer can enter role/job title, as illustrated in FIG. 35, and add application questions, as illustrated in FIG. 37. The employment matching system 102 (and/or the application 220) can pull through all of the information, the job description, and any hard skills or soft skills can then be added to build a card or tile, as illustrated in FIG. 38. To build a card or tile, the employment matching system 102, for example, via the interface module 240 (and/or the application 220) can generate interfaces for organizations, e.g., the employer interface 450, which allows intelligent stock photo integration (e.g., a gallery called “Pixel”), so that based on the job title it will pull through relevant images, as illustrated in FIG. 39. The builder of an employment card or tile can select those images, pull them into the card or tiles to create a job campaign and move forward, as illustrated in FIG. 40. A blank image of color with text overlay can also be chosen, to build out a particular tile. Thus, there are different ways of being able to build cards, and the app makes it simple, as illustrated in FIG. 41. Uploads of video can also be possible instead of photography. Then review of what those cards and the full job campaign will actually look like may occur, as illustrated in FIG. 42. At that point, the job can be posted, as illustrated in FIG. 43.

In embodiments, the employment matching system 102, for example, via the interface module 240, (and/or the application 220) can generate interfaces for organizations, e.g., the employer interface 450, that permits creation of multiple employment cards for a single position, with split (A/B) and multi variant testing. This allows turning the advertising of a job into the marketing of a job. Split testing is where different front cards, or different images on two different front cards, get released. Multi Variant is where more than two different front cards can be used so different audiences can be targeted with different job advertisements. This allows enterprises to deeply, emotively and directly target their intended audiences with an advertisement that appeals to them. Then the platform will provide analytics and metrics behind how those are performing. This may include how many people viewed the card, how many cards they swiped through, whether they scrolled, whether they watched the corporate video, and then ultimately whether they applied or passed on the job and whether they answered any pre-qualifying questions that may have been required. This provides a good idea of who is applying, where they are dropping off, and what ethnicities, ages or experience levels are being lost, etc. Split testing and multivariate testing can be incredibly powerful for organizations to be able to constantly optimize their job posts. Based on the analytics, the series of employment cards to be presented to a user can be dynamically selected by the employment matching system 102 based on a profile of the user matched with the employment opportunity.

In one embodiment, the enterprise app allows for the first piece of card creative to add up to five different variants. So one could have, for example, a Chinese person, an Indian person, a European and an African American. One could do five different instances of creative for that first card, and then target that creative to the right demographic.

In embodiments, the employment matching system 102, for example, via the interface module 240, (and/or the application 220) can generate interfaces for candidate, e.g., the candidate interface 400, that builds up their CV, the platform stores ethnicity data, in addition to other demographics like age data, some or all of which can then be used to target the particular creative. The employment matching system 102 (and/or the application 220) can pull through deeper analytics that have ever been identified or recognized before for the advertising of jobs.

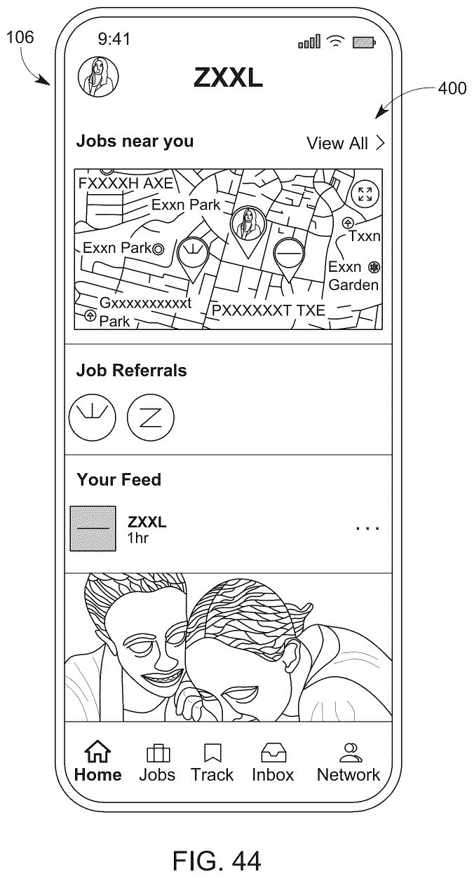

In embodiments, the employment matching system 102, for example, via the interface module 240, (and/or the application 220) can generate interfaces for candidate, e.g., the candidate interface 400, that a home page provides as general overview of the user 104 including a map with nearby jobs, job referrals, and a job feed, as illustrated in FIG. 44. To access account and profile information, the user 104 can select the “account” widget from the widgets 420. The account and profile information can include profile, CV, cover letter, videos, which can be viewed using widgets 426.

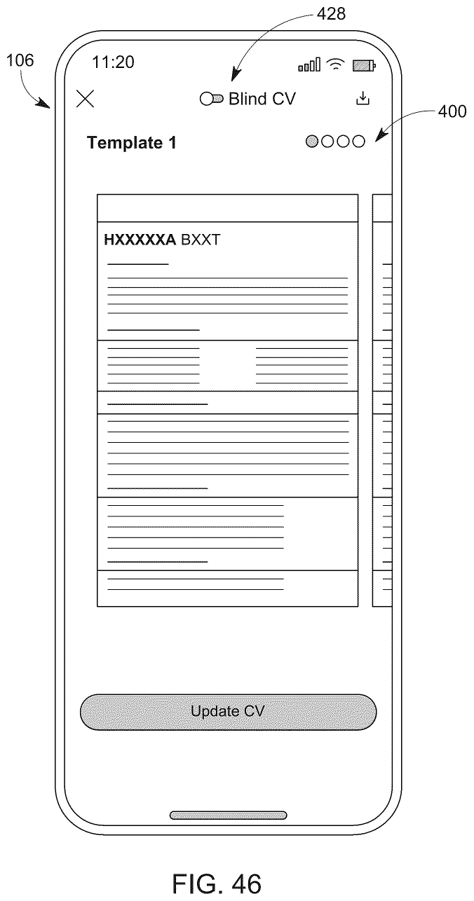

In embodiments, the employment matching system 102, for example, via the interface module 240, (and/or the application 220) can generate interfaces for candidate, e.g., the candidate interface 400, that allows the user 104 to automatically generate and edit a CV using the profile information and pre-defined templates. For example, as illustrated in FIGS. 46-48, the user 104 can select to generate and/or edit a CV, and the interface module 240, (and/or the application 220) can generate a CV using the pre-defined templates. The user 104 can view the different CVs generated using the different templates. The candidate interface 400 can also include a blinding widget 428. The blinding widget 428 can remove any personal and/or identifying information, from the CV, that reveals the identity, gender, race, ethnicity, age, etc. of the user 104.

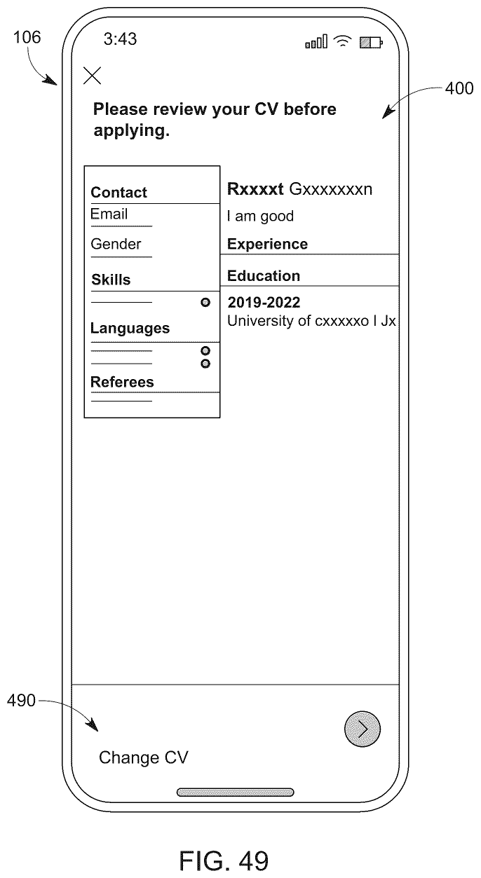

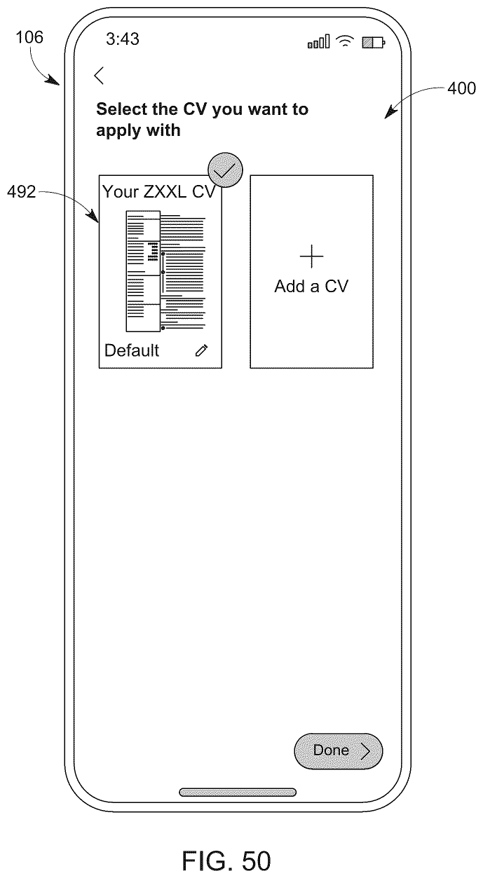

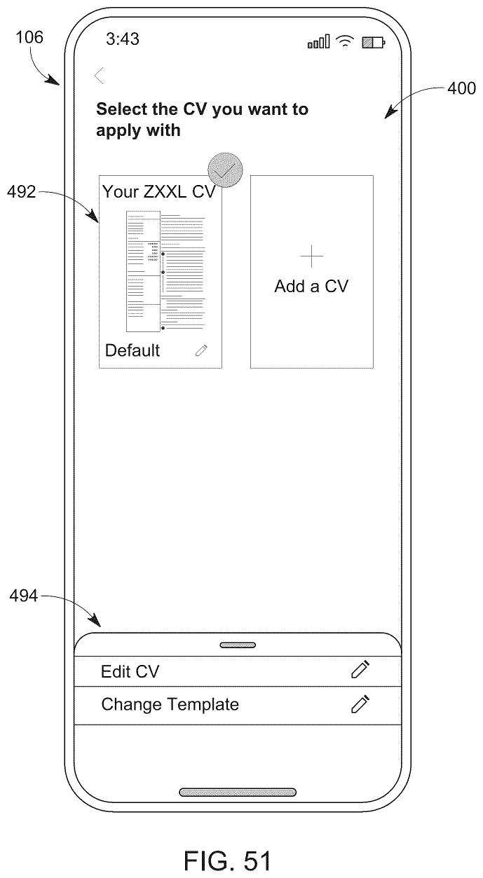

In embodiments, the employment matching system 102, for example, via the interface module 240, (and/or the application 220) can enable the user to edit and update a CV during the application process. When the user 104 selects to apply for the job, the candidate interface 400 can generate a widget that allows the user to begin editing a CV, after the application process has begun and during the application process. For example, as illustrated in FIG. 50, when the user 104 selects to apply to a job, the employment matching system 102, for example, via the interface module 240, (and/or the application 220) provides a selection widget 492 that allows the user 104 to select an existing CV or add a new CV. As illustrated in FIG. 49, once the user 104 selects a CV, the CV can be presented to the user 104 for review, and the candidate interface 400 can include a change CV widget 490. If the change CV widget 490 is selected, the employment matching system 102, for example, via the interface module 240, (and/or the application 220) can generate an editing selection menu 494, that allows the user 104 to edit the existing CV or change a template for the CV. If the user 104 selects one of the editing features and completes the selection (e.g., revising questionnaire answers or picking a new template), the CV may, for example, have changes as illustrated in FIG. 46-48 and described above.

Returning to FIG. 2, in embodiments, the profile module 242 can be configured to receive the information provided to the user 104 and store the information as a digital profile for the user 104. In the profile module 242 can also store templates for generating CVs for the user.

In embodiments, the searching/matching module 244 can be configured to match one or more potential employment opportunities with the user 104. The matching can be based on the profile of the user 104, search terms provided by the user 104, and combinations thereof. The searching/matching module 244 can be configured to match job listings with candidates based on a scoring system. For example, the higher the score, the more relevant the job listing is to the candidate (e.g., the user 104). In embodiment, the scoring can range from 0-100 with 4 decimal places (e.g., 0.0000-100.0000), where 100 is the highest scoring match that can be made, and 0 is no match at all. Various aspects of the job listing and the candidate are scored (0-100), then each of these scores are weighted and summed to an overall score of 0-100.

The searching/matching module 244 can be configured to execute a scoring pipeline that scores various metrics that are weighted and summed to determine an overall score. The metrics can include location, education, work experience, skill, and industry. Each step of the scoring pipeline can utilize different algorithms and technologies for scoring, e.g., geo-spatial functions, natural language processing (NLP), score matrices, etc. Below is pseudo-code for the scoring pipeline using weightings.

| | |
|---|---|
| 1 | [symbol] PrepareJobListingStackF [symbol] UserId) |
| 2 | { |
| 3 | // [symbol] Jobs |
| 4 | User = SetUserFromDB(UserId) // get user from database |
| 5 | Locationweighting, Educationalweighting, WorkExperienceweighting, Skillsweighting [symbol] Weightings(User) // [symbol] will vary between users |
| 6 | JobListing[ ] = GetJobListingsfromDB(User.Location, Limit [symbol] ) // get list of jobs [symbol] filtered by user location [symbol] |
| 7 | |
| 8 | // Location |
| 9 | LocationScore[i] = ScoreLocations(User, Location, JobListing[i].Location) // [symbol] |
| 10 | WeightedLocationScore[i] = LocationScore[i] × LocationWeighting // eg [symbol] |
| 11 | |
| 12 | // Education |
| 13 | EducationScore[i] = ScoreEducation(User, TopQualification, JobListing[i].Job [symbol] |
| 14 | WeightedEducationScore[i] = EducationScore[i] × EducationWeighting // eg [symbol] |
| 15 | |
| 16 | // Work Experience |
| 17 | WorkExperienceScore[i] = ScoreWorkExperience(User, JobListing) // [symbol] |
| 18 | WeightedWorkExperienceScore[i] = WorkExperienceScore[i] × WorkExperienceWeighting // eg [symbol] |
| 19 | |
| 20 | // Skills |
| 21 | SkillsScore[ ] = ScoreSkills(user.Location [symbol] Job.Location) // [symbol] |
| 22 | WeightedSkillsScore[i] = SkillsScore[i] × SkillsWeighting // eg [symbol] |
| 23 | |
| 24 | userJobListingScores[i] = WeightedLocationScore[i] + WeightedEducationScore[i] + WeightedWorkExperienceScore[i] + WeightedSkillsScore[i] |
| 25 | |
| 26 | // [symbol] stack size |
| 27 | if (UserJobListingScores Size >= [symbol] ) |
| 28 | UserJobListingScores = UserJobListingScores [symbol] t(25) |
| 29 | else |
| 30 | UserJobListingScores.A [symbol] Up.JobListings [symbol] UserJobListingScore.Size [symbol] |
| 31 | |
| 32 | // [symbol] |
| 33 | WriteUserJobScoresToDB(UserId, UserJobListingScores; |
| 34 | } |

[symbol]

indicates data missing or illegible when filed

The searching/matching module 244 can calculate the weightings that are used against each score (e.g., location, education, work experience, skills, industry) for each user. The weightings for education and work experience can vary depending on where the user is in their career. For instance, a user that has just finished university has no work experience, and hence their work experience weighting can be 0%, whereas their education weighting should be quite a high percentage such as 70%. The searching/matching module 244 can consider factors such as should the weightings be calculated once for the user and applied to all job listings equally, or should a job listing also have some influence on the weighting in some cases. The searching/matching module 244 can consider factors such as should all weights add to 100% or will this skew some scores. For instance, if a job listing requires someone very experienced with a certain qualification, and a student has that qualification but no experience, the student could score highly for that job if a large weighting is attributed to the education score. This can be undesirable as the specific job listing requires significant experience. In embodiments, searching/matching module 244 can calculate weightings per user and per job listing. Table 1 lists one example of weighting of different factors.

TABLE 1

| Weighting Category | Factors | Example Weighting |
|---|---|---|
| Location | Location is used as a filter | 10% |
| | initially. | |
| | But then used as a | |
| | closeness score | |
| Job Title | Job title is pulled from | 30% |
| | qualification major and/or | |
| | the candidates specified | |
| | job title. | |
| | These are weighted over | |
| | 0 . . . 5 years. Then the | |
| | resulting score is used. | |
| Seniority | Weight should be high if | 30% |
| | much work experience | |
| | and low if no work | |
| | experience, and | |
| | graduated in between. | |
| Skills | Skills can allow users to | 20% |
| | be treated the same. | |
| | Additionally, the job listing | |
| | may have a bearing on | |
| | this weight | |
| Industry | This is an all or nothing | 10% |
| | score, so it will be 0% or | |
| | 100% | |
| | | Sum of weights should |
| | | equal 100% |

The searching/matching module 244 can implement one or more scoring rules that are applied to the job matching algorithms. Table 2 illustrates examples of rules that can be applied to the job matching algorithms.

| Rule | Database/Code | | | | Comments |
|---|---|---|---|---|---|
| Filtering | | | | | |
| Only Job | job_listing_type.code = ‘JOB_LISTING’ | | | | Exclude job |
| Listings | | | | | templates and |
| | | | | | job listing |
| | | | | | demos |
| Only Open | job_listing.stage.code = ‘OPEN’ | | | | Only select |
| Job Listings | | | | | OPEN job |
| | | | | | listings |
| Exclude | deleted_date IS NULL | | | | Exclude all |
| deleted job | | | | | deleted job |
| listings | | | | | listings |
| Preferred | user_profile.preferred_job_listing_location_type | | | | city, region, |
| location filter | | | | | country or |
| | | | | | anywhere - |
| | | | | | filter out the |
| | | | | | jobs that do not |
| | | | | | fit into the |
| | | | | | candidate's |
| | | | | | preferred |
| | | | | | location |
| Job Stack | | | | | |
| Size | | | | | |
| Maximum | count(user_job_listing) <= 25 | | | | Only allow a |
| size = 25 | | | | | maximum of 25 |
| | | | | | active job |
| | | | | | listings on any |
| | | | | | candidate's job |
| | | | | | stack at any |
| | | | | | one time |
| | | | | | (optional) |
| Minimum | user_job_listing_suggestion.match_score >= 0 | | | | Do not cut off |
| score = 0 | | | | | any jobs due to |
| | | | | | a low score |
| Metric | | | | | |
| Scoring | | | | | |
| Location | user_detail.location.longitude | | | | Score the job |
| | user_detail.location.latitude vs | | | | listing location |
| | job_listing.location.longitude | | | | vs the |
| | job_listing.location.latitude | | | | candidate's |
| | | | | | home address |
| | | | | | on a straight- |
| | | | | | line distance |
| | | | | | basis. Apply a |
| | | | | | half-bell curve |
| | | | | | formula on the |
| | | | | | distance |
| | | | | | starting with |
| | | | | | score 100 |
| | | | | | tending |
| | | | | | towards a |
| | | | | | score of 0. |
| Job Title | | | | | Use the |
| (work exp > 5 | | | | | Candidate Job |
| years) | | | | | Title score |
| | | | | | only. |
| | | | | | Discard the |
| | | | | | Major to Job |
| | | | | | Title score |
| | Work Experience | | Job Title | Job Title (from | |
| | (Years) | | (from major) | Candidate) | |
| Job Title | 0 | years | 100% | 0% | Add both Major |
| (work exp <= | 1 | year | 80% | 20% | to Job Title |
| 5 years) | 2 | years | 60% | 40% | score |
| | 3 | years | 40% | 60% | (weighted) + |
| | 4 | years | 20% | 80% | Candidate Job |
| | 5 | years | 0% | 100% | Title score |

| | | | | (weighted) for |
|---|---|---|---|---|
| | overall job title | | | |
| | score. | | | |
| | Weightings are | | | |
| | based on the | | | |
| | first 5 years | | | |
| | work | | | |
| | experience as | | | |
| | shown. | | | |
| Major to Job | | | | Score the job |
| Title | | | | listing job title |
| | | | | against the |
| | | | | candidate's |
| | | | | education |
| | | | | major. Use a |
| | | | | pre- |
| | | | | determined |
| | | | | score matrix for |
| | | | | this. |
| Candidate | coalesce(user_profile.current_job_title, | | | Score the job |
| Job Title | user_profile.current_job_title_other) | | | listing job title |
| | vs | | | against the |
| | job_title.title | | | candidate's job |
| | | | | title (Netflix |
| | | | | question) using |
| | | | | similarity |
| | | | | scoring. |
| | | | | This rule can |
| | | | | also include |
| | | | | vectorization |
| | | | | and/or NLP |
| | | | | algorithms |
| | user_profile.experience_level vs | | | |
| | job_listing.experience_level | | | |
| | User | Job | Score | |
| Seniority | 0 | 0 | 50% | Compare the |
| | 0 | n | 50% | experience |
| | n | 0 | 50% | level of the |
| | n | n − 2 | 0% | candidate |
| | n | n − 1 | 20% | against the job |
| | n | n | 75% | listing. Higher |
| | n | n + 1 | 100% | score is given |
| | n | n + 2 | 50% | to a upward |
| | n | n + 3 | 10% | movement in |
| | n | n + 4 | 0% | seniority. Use |

| | | |
|---|---|---|
| | | the table |
| | shown to | |
| | establish the | |
| | score. | |
| | NOTE: If there | |
| | is no user | |
| | and/or job | |
| | experience | |
| | level (as shown | |
| | by the red | |
| | cells) then | |
| | default the | |
| | score to 50%. | |
| Industry | user_preferred_industry vs | Score the |
| | organisation.industry | candidate's |
| | | skills against |
| | | the job listing's |
| | | skills using |
| | | similarity |
| | | scoring for |
| | | each individual |
| | | comparison. |
| | | Then multiply |
| | | each skill score |
| | | against the |
| | | candidate's |
| | | skill rating for |
| | | that skill |
| Skill Similarity | max(similarity(candidate skills vs job skill n)) | Score the |
| Score | where similarity >= 50% | candidate's |
| | | skills against a |
| | | job listing's skill |
| | | using similarity |
| | | scoring for |
| | | each individual |
| | | comparison. |
| | | Take the |
| | | highest scoring |
| | | candidate skill |
| | | as the similarity |
| | | score. Any |
| | | similarity score |
| | | <50% set to |
| | | 0% |
| Skill Rating | user_skill.rating rating 1 = 20% | Multiply the |
| | rating 2 = 40% | skill similarity |
| | rating 3 = 60% | score for each |
| | rating 4 = 80% | skill against the |
| | rating 5 = 100% | candidate's |
| | | skill rating. |
| | | Multiply the |
| | | skill rating by |
| | | 20 to give a |
| | | strength |
| | | percentage |
| | | (i.e. 20%, 40%, |
| | | 60%, 80%, |
| | | 100%) to |
| | | multiply the |
| | | score by. |
| | | Individual skill |
| | | score = skill |
| | | similarity × skill |
| | | rating strength |
| | | percentage |
| | | e.g. score = |
| | | 76.5 × 60% |
| | | (rating 3) = |
| | | 45.9 |
| Weightings | | |
| Candidate | Overall score = sum( | Sum the |
| Job Listing | location score × location weighting, job title | weighted |
| Score | score × job title weighting, seniority score × | scores of |
| | seniority weighting, industry score × industry | location, job |
| | weighting, | title, seniority, |
| | skill score × industry weighting) | industry and |
| | | skill based on |
| | | the weights |
| | | discussed in |
| | | Weightings |
| | | Logic |
| | | All the weights |
| | | add to 100%. |
| Output | | |
| Candidate | user_job_listing (state) | Once scored |
| Job Listing | user_job_listing_suggestion (score) | store the |
| Stack | | matched job |
| | | listings into the |
| | | candidate's job |
| | | stack. |
| | | Mark the old |
| | | job listings on |
| | | the stack as |
| | | deleted. |
| Score | | store metric |
| Logging | | scores and |
| | | matching runs |
| | | in DB |

In embodiments, the searching/matching module 244 can utilize various tables stored in the databases 214. Table 3 lists examples of tables that can be utilized.

TABLE 3

| Data Table | Relevance | Comments |
|---|---|---|
| User | Match - left side | |
| Job Listing | Match - right side | |
| User Job Suggestion | Matched record | Includes score |
| Skill | Common entity | User & Job Listing both |
| | | list skills. |
| Job Title | Common entity | User & Job Listing both |
| | | have job title. |
| | | For students convert |
| | | study major to job title. |
| Experience/Seniority | Common entity | User & Job Listing both |
| | | have experience levels. |
| Industry | Common entity | User has industries they |
| | | are interested in |
| | | Industry for Enterprise is |
| | | at organisation level |
| Location | Common entity | User & Job Listing both |
| | | have location (can be |
| | | broken down at country, |
| | | city, suburb level) |
| Job Listing Watchlist | User intent | User showing an interest |
| Job Listing Application | User intent | User very interested |
| Organization User | User intent | User interested in job |
| Relationship | | listing organization |
| User Job Search | User intent | What are they searching |
| History | | for |
| Employment History | User intent | Similarities between |
| | history | organizations |
| Education History | Inferencing | Insights may link |
| | | historical roles to future |
| | | roles |
| User Award | Inferencing | Insights may link award to |
| | | job role, industry or level |
| User License | Inferencing | Insights may link |
| Certification | | certificate to job role, |
| | | industry or level |
| Extra Curricular | Inferencing | Insights may link activity |
| Activity | | to aptitude in role or |
| | | industry |

In embodiments, the searching/matching module 244 can perform the matching and/or searching based on different conditions. For example, the searching/matching module 244 can perform job matching using a brute force. In this example, the searching/matching module 244 can iterate all candidates against all job listings overnight, so everyone's job stack is up to date daily. In another example, the searching/matching module 244 can perform real-time matching. In this example, there can be primary touch points from a user's interaction in the employment matching system 102 and/or the application 220, that require job matching to be re-scored before the candidate's job stack is viewed, as follows. In one touch point, scoring can be performed when a new user is added, e.g.,initial stack needs to be generated prior to viewing the job stack. In another touch point, scoring can be performed when a new job listing is added, e.g., an organization or agent posts a new job listing. In another touch point, scoring can be performed when an existing user changes state, e.g., when a user alters any of the attributes affecting the score/matching. In another touch point, scoring can be performed when an existing job listing changes state, e.g., when a job listing expires, is filled, withdrawn, edited. In one example, a time to run the job matching algorithm can be immediately before the candidate's job stack is viewed.

In embodiments, the posting module 246 can be configured to receive information for a job post from the employer 114 and generate an employment card. The posting module 246 can store the jobs cards for the employer 114 and provide the employment cards to user device 106 based on searching and/or matching.

The processing device 204, the communication device 206, the memory device 208, and the I/O interface 210 can be interconnected via a system bus. The system bus can be and/or include a control bus, a data bus, an address bus, and so forth. The processing device 204 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device. While FIG. 1 illustrates a single processing device 204, the employment matching system 102 can include multiple processing devices 204, whether the same type or different types.

The memory device 208 can be and/or include computerized storage medium capable of storing electronic data temporarily, semi-permanently, or permanently. The memory device 208 can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device. While FIG. 1 illustrates a single memory device 208, the employment matching system 102 can include multiple memory devices 208, whether the same type or different types.

The communication device 206 enables the employment matching system 102 to communicate with other devices and systems. The communication device 206 can include, for example, a networking chip, one or more antennas, and/or one or more communication ports. The communication device 206 can generate radio frequency (RF) signals and transmit the RF signals via one or more of the antennas. The communication device 206 can generate electronic signals and transmit the RF signals via one or more of the communication ports. The communication device 206 can receive the RF signals from one or more of the communication ports. The electronic signals can be transmitted to and/or from a communication hardline by the communication ports. The communication device 206 can generate optical signals and transmit the optical signals to one or more of the communication ports. The communication device 206 can receive the optical signals and/or can generate one or more digital signals based on the optical signals. The optical signals can be transmitted to and/or received from a communication hardline by the communication port, and/or the optical signals can be transmitted and/or received across open space by the communication device 206.

The communication device 206 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The employment matching system 102 can communicate with one or more network resources via the network 112. The one or more network resources can include external databases, social media platforms, search engines, file servers, web servers, or any type of computerized resource that can communicate with the employment matching system 102 via the network 112.

Various aspects of the systems described herein can be referred to as “information,” “content,” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the networked employment search environment 100, including the employment matching system 102, the user device 106, and/or the employer device 116 can provide I/O devices for outputting information in a format perceptible by a user and receiving input from the user. For example, the employment matching system 102 can communicate with the I/O devices via the I/O interface 210. The I/O devices can display graphical user interfaces (“GUIs”) generated by the employment matching system 102 and/or the application 220. The I/O devices can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The I/O devices can include an acoustic element such as a speaker, a microphone, and so forth. The I/O devices can include a button, a switch, a keyboard, a touch-sensitive surface, a touchscreen, a camera, a fingerprint scanner, and so forth. The touchscreen can include a resistive touchscreen, a capacitive touchscreen, and so forth.

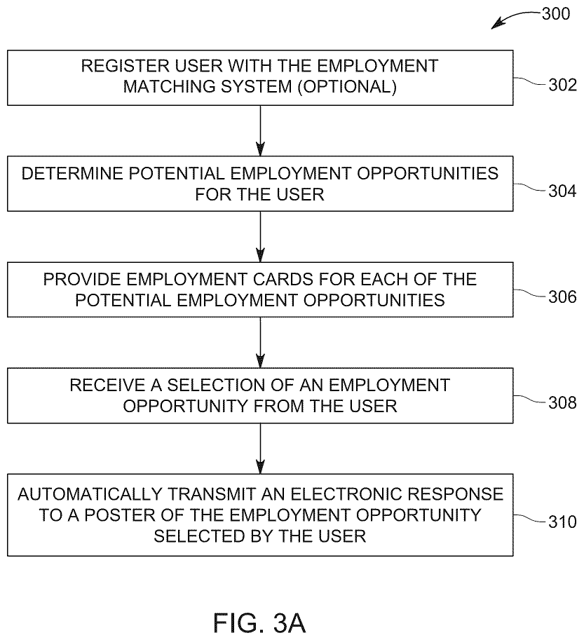

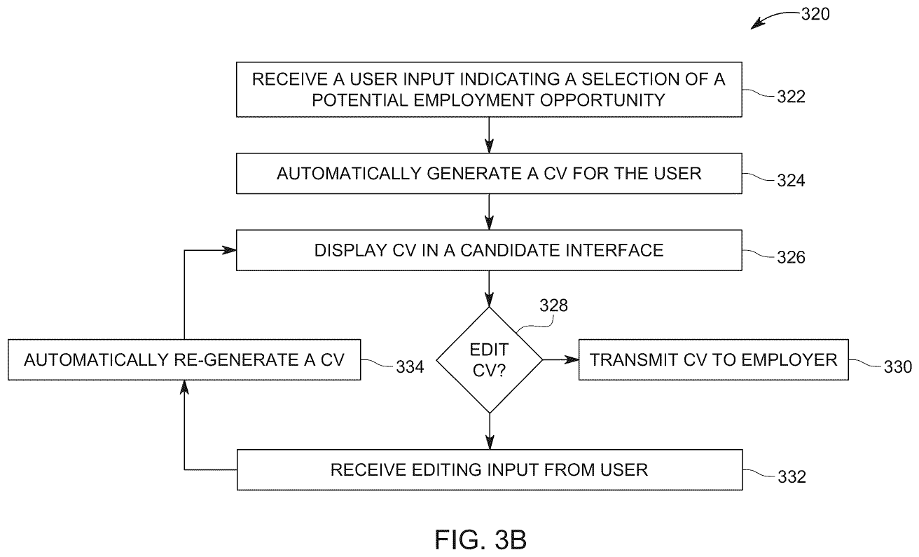

FIG. 3A illustrates a method 300 for matching users and employers, according to aspects of the present disclosure. While FIG. 3 illustrates various stages of the method 300, additional stages can be added, and existing stages can be removed and/or reordered. In embodiments, the method 300 can be performed by the employment management system 102 and/or the application 220. In embodiment, information presented to a user and/or input received from the user can be provided/received by one or more GUls, for example, candidate interface 400 described above.

At stage 302, a user can register with the employment matching system. For example, the user 104 can register upon the first connection with the employment matching system 102. The user 104 can establish login information, e.g., a username and password, that provides access to the application 220 and/or the employment matching system 102. The user 104 can use login information to connect with the employment matching system during subsequent visits. During registration, the user 104 can provide details and preferences, and create a CV using the interfaces described above. A digital profile for the user can be generated for the user based on the CV created and information entered by the user.

At stage 304, the employment matching system can determine potential employment opportunities for the user. In some embodiments, the employment matching system 102 can determine potential employment opportunities by applying the digital profile of the user to matching algorithms, e.g., scoring algorithms, one or more machine learning algorithms, etc. In some embodiments, the employment matching system 102 can search for potential employment opportunities based on search terms entered by the user.

At stage 306, the employment matching system can provide employment cards for each of the potential employment opportunities. In embodiments, each potential employment opportunity can include an employment card or a series of employment cards that provide details of the potential employment opportunities, as described above. The employment card or series of employment cards can be interacted with by the user 104 to navigate the series of employment cards, link to additional information about the employment opportunity, apply to the employment opportunity, and the like.

At state 308, the employment matching system can receive a selection of an employment opportunity from the user. The user can select an employment opportunity by inputting a gesture on the employment card associated with the employment opportunity, e.g., a direction swipe, a tap, a predefined motion pattern, and the like.

At stage 310, the employment matching system can automatically transmit an electronic response to a poster of the employment opportunity selected by the user. In some embodiments, the employment matching system 102 can automatically send the CV of the user 104 to the poster, e.g., the employer 114, of the employment opportunity.

FIG. 3B illustrates a method 320 for editing a CV, according to aspects of the present disclosure. While FIG. 3 illustrates various stages of the method 300, additional stages can be added, and existing stages can be removed and/or reordered. In embodiments, the method 320 can be performed by the employment management system 102 and/or the application 220. In embodiment, information presented to a user and/or input received from the user can be provided/received by one or more GUls, for example, candidate interface 400 described above.

At stage 322, user input can be received indicating a selection of a potential employment opportunity. In embodiments, the employment management system 102 and/or the application 220 can present employment cards to a user that correspond to an employment opportunity. The employment cards can include a widget to apply to the employment opportunity. The user 104 can select the widget to apply for the employment opportunity, which initiates an application process in the employment management system 102 and/or the application 220.

At stage 324, a CV can be automatically generated for the user. In embodiments, the employment management system 102 and/or the application 220 can retrieve a profile of the user and use the information of the profile to populate a predefined template. It will be understood that in the method shown in FIG. 3B, the CV can exist in the employment management system 102 and/or the application 220 in one of either two ways. First, the employment management system 102 and/or the application 220 can permit composing a new CV with a simple questionnaire selected by the user. After completion of the questionnaire, containing conventional field entries for experience, education, goals, etc. the system at the servers maintains such fields in a database, ready for presentation on a user device or employer device as a CV GUI for that particular person. Second, a user may have uploaded a CV via an upload thumbnail icon, from a CV file residing on a computer system of the user, e.g., the user device 106.

At stage 326, the CV can be displayed in a candidate interface. The employment management system 102 and/or the application 220 can display the CV in the candidate interface 400. The candidate interface 400 can include a widget and/or button that allows the user 104 to edit the CV during the application process.

In stage 328, it can be determined if the user selected editing the CV. If not, in stage 330, the CV can be transmitted to the employer associated with the employment opportunity. In some embodiments, the employment matching system 102 can automatically send the CV of the user 104 to the poster, e.g., the employer 114, of the employment opportunity.

It will be understood that in the method shown in FIG. 3B, the CV already exists in the system in one of either two ways. First, the system permits composing a new CV with a simple questionnaire selected by the user. After completion of the questionnaire, containing conventional field entries for experience, education, goals, etc. the system at the servers maintains such fields in a database, ready for presentation on a user device or employer device as a CV GUI for that particular person. Second, a user may have uploaded a CV via an upload thumbnail icon, from a CV file residing on the user's mobile device.

In stage 332, if editing is selected, editing input can be received from the user. For example, the employment management system 102 and/or the application 220 can provide one or more buttons or widgets to change the information included in the CV and/or change the pre-defined template used to generate the CV. For instance, as described above, the user 104 can select to generate and/or edit a CV, and the interface module 240, (and/or the application 220) can generate a CV using the pre-defined templates. The user 104 can view the different CVs generated using the different templates. The candidate interface 400 can also include a blinding widget 428. The blinding widget 428 can remove any personal and/or identifying information, from the CV, that reveals the identity, gender, race, ethnicity, age, etc. of the user 104.

Once the editing input is received, in stage 334, the CV can be automatically regenerated based on the editing input, and the method can return to stage 326 to display the CV to the user.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A method for employment searching, the method comprising:
determining one or more potential employment opportunities for a user, wherein the one or more potential employment opportunities are determined as output from one or more matching algorithms or a user based search;
providing a graphical user interface comprising an employment card or a series of employment cards for each of the one or more potential employment opportunities;
receiving, from the user, a first input gesture associated with a first employment card, wherein the first input gesture represents an interest in a first employment opportunity from the one or more potential employment opportunities; and
automatically transmitting an electronic response to a poster of the first employment opportunity in response to the first input gesture.

2. The method of claim 1, the method further comprising:
receiving, from the user, a second input gesture associated with a second employment card, wherein the second input gesture represents a disinterest in a second employment opportunity from the one or more potential employment opportunities; and
automatically removing the second employment opportunity from the one or more potential employment opportunities in response to the second input gesture.

3. The method of claim 2, wherein the first input gesture or the second input gesture is a directional swipe.

4. The method of claim 1, wherein the employment card or the series of employment cards for each of the one or more potential employment opportunities comprises a graphical image that conveys a field of the one or more potential employment opportunities, a location of the one or more potential employment opportunities, and details of the one or more potential employment opportunities.

5. The method of claim 1, wherein determining one or more potential employment opportunities comprises:
retrieving a stored profile for the user;
retrieving a listing of available employment opportunities; and
applying, as input to one or more machine learning algorithms, one or more parameters from the stored profile and the listing of available employment opportunities, wherein the one or more machine learning algorithms are trained to output the one or more potential employment opportunities.

6. The method of claim 1, wherein the determining one or more potential employment opportunities comprises:
receiving one or more search terms from the user;
retrieving a listing of available employment opportunities; and
applying, as input to the one or more machine learning algorithms, the one or more search terms and the listing of available employment opportunities, wherein the one or more machine learning algorithms are trained to output the one or more potential employment opportunities.

7. The method of claim 1, the method further comprising:
receiving, from the user, a second input gesture associated with the first employment card; and
automatically determining a geographic location of the user based on location services provided by a user device; and
providing a directional map to a location of the first employment opportunity.

8. A computer-readable medium storing instructions that cause one or more processors to perform a method, the method comprising:
determining one or more potential employment opportunities for a user, wherein the one or more potential employment opportunities are determined as output from one or more matching algorithms or a user based search;
providing a graphical user interface comprising an employment card or a series of employment cards for each of the one or more potential employment opportunities;
receiving, from the user, a first input gesture associated with a first employment card, wherein the first input gesture represents an interest in a first employment opportunity from the one or more potential employment opportunities; and
automatically transmitting an electronic response to a poster of the first employment opportunity in response to the first input gesture.

9. The computer-readable medium of claim 8, wherein the instructions cause one or more processors to perform the method further comprising:
receiving, from the user, a second input gesture associated with a second employment card, wherein the second input gesture represents a disinterest in a second employment opportunity from the one or more potential employment opportunities; and
automatically removing the second employment opportunity from the one or more potential employment opportunities in response to the second input gesture.

10. The computer-readable medium of claim 9, wherein the first input gesture or the second input gesture is a directional swipe.

11. The computer-readable medium of claim 8, wherein the employment card or the series of employment cards each of the one or more potential employment opportunities comprises a graphical image that conveys a field of the one or more potential employment opportunities, a location of the one or more potential employment opportunities, and details of the one or more potential employment opportunities.

12. The computer-readable medium of claim 8, wherein the instructions cause one or more processors to perform the method further comprising:
retrieving a stored profile for the user;
retrieving a listing of available employment opportunities; and
applying, as input to one or more machine learning algorithms, one or more parameters from the stored profile and the listing of available employment opportunities, wherein the one or more machine learning algorithms are trained to output the one or more potential employment opportunities.

13. The computer-readable medium of claim 8, wherein the instructions cause one or more processors to perform the method further comprising:
receiving one or more search terms from the user;
retrieving a listing of available employment opportunities; and
applying, as input to the one or more machine learning algorithms, the one or more search terms and the listing of available employment opportunities, wherein the one or more machine learning algorithms are trained to output the one or more potential employment opportunities.

14. The computer-readable medium of claim 8, wherein the instructions cause one or more processors to perform the method further comprising:
receiving, from the user, a second input gesture associated with the first employment card; and
automatically determining a geographic location of the user based on location services provided by a user device; and
providing a directional map to a location of the first employment opportunity.

15. A system comprising:
one or more memory devices storing instructions;
one or more processors configured to execute the instructions to perform a method, the method comprising:
determining one or more potential employment opportunities for a user, wherein the one or more potential employment opportunities are determined as output from one or more matching algorithms or a user based search;
providing a graphical user interface comprising an employment card or a series of employment cards for each of the one or more potential employment opportunities;
receiving, from the user, a first input gesture associated with a first employment card, wherein the first input gesture represents an interest in a first employment opportunity from the one or more potential employment opportunities; and
automatically transmitting an electronic response to a poster of the first employment opportunity in response to the first input gesture.

16. The system of claim 15, wherein the one or more processor is configured to execute the instructions to perform the method further comprising:
receiving, from the user, a second input gesture associated with a second employment card, wherein the second input gesture represents a disinterest in a second employment opportunity from the one or more potential employment opportunities; and
automatically removing the second employment opportunity from the one or more potential employment opportunities in response to the second input gesture.

17. The system of claim 16, wherein the employment card or a series of employment cards for each of the one or more potential employment opportunities comprises a graphical image that conveys a field of the one or more potential employment opportunities, a location of the one or more potential employment opportunities, and details of the one or more potential employment opportunities.

18. The system of claim 15, wherein the one or more processor is configured to execute the instructions to perform the method further comprising:
retrieving a stored profile for the user;
retrieving a listing of available employment opportunities; and
applying, as input to one or more machine learning algorithms, one or more parameters from the stored profile and the listing of available employment opportunities, wherein the one or more machine learning algorithms are trained to output the one or more potential employment opportunities.

19. The system of claim 15, wherein the one or more processor is configured to execute the instructions to perform the method further comprising:
receiving one or more search terms from the user;
retrieving a listing of available employment opportunities; and
applying, as input to the one or more machine learning algorithms, the one or more search terms and the listing of available employment opportunities, wherein the one or more machine learning algorithms are trained to output the one or more potential employment opportunities.

20. The system of claim 15, wherein the one or more processor is configured to execute the instructions to perform the method further comprising:
receiving, from the user, a second input gesture associated with the first employment card; and
automatically determining a geographic location of the user based on location services provided by a user device; and
providing a directional map to a location of the first employment opportunity.

21. A method for network employment engagement, the method comprising:
determining one or more potential employment opportunities for a user, wherein the one or more potential employment opportunities are determined as output from one or more matching algorithms or a user based search;
providing a graphical user interface (GUI) comprising an employment card or a series of employment cards for each of the one or more potential employment opportunities;
receiving, from the user, a first input gesture associated with a first employment card representing, the first input gesture initiating an application process for a first potential employment opportunity; and
generating a curriculum vitae (CV) based on profile information for the user and a predefined template; and
presenting the CV to the user in the GUI, the GUI comprising an editing item that allows editing the CV.

22. The method of claim 21, the method further comprising:
receiving, from the user, a selection of the editing item;
providing, in the GUI, a CV editing page comprising one or more editing options;
receiving, via the one or more editing options, editing input from the user; and
re-generating the CV based on the editing input form the user.

23. The method of claim 22, wherein the editing input comprises a selection of a new pre-defined template.

24. The method of claim 22, wherein the editing input comprises a selection to remove identifying and personal information from the CV.

25. The method of claim 21, the method further comprising:
transmitting the CV to a poster of the first employment opportunity.
